(19) United States
(12) Patent Application Publication
(10) Pub. No.: US 2025/0310014 A1
(43) Pub. Date: Oct. 2, 2025

(54) EXTENDING eCPRI BASED DELAY MEASUREMENT PROCEDURE IN DISTRIBUTED ANTENNA SYSTEMS

(71) Applicant: Outdoor Wireless Networks LLC, Richardson, TX (US)

(72) Inventors: Suman Saurav, Bhagalpur (IN); Shiva Prakash, Bangalore (IN)

(73) Assignee: Outdoor Wireless Networks LLC, Richardson, TX (US)

(21) Appl. No.: 19/092,928

(22) Filed: Mar. 27, 2025

Related U.S. Application Data
(60) Provisional application No. 63/570,674, filed on Mar. 27, 2024.

(51) Int. Cl. H04B 17/364

(52) U.S. Cl. CPC H04B 17/364

(57) ABSTRACT

The present disclosure describes techniques for delay measurement in Distributed Antenna Systems (DASs). In an aspect, a method comprises transmitting, by a distributed unit (DU), a plurality of delay measurement requests to a remote radio head (RRH) for uplink delay measurement and downlink delay measurement, receiving, from the RRH, a plurality of delay samples in response to the plurality of dummy packets being transmitted, determining, by the DU, downlink transport delays at least based on the plurality of delay samples and DU timing parameters, determining, by the DU, uplink transport delays at least based on the plurality of delay samples, and transmitting a DU delay profile to the RRH for adjustment a RRH transmission window and a RRH reception window, the DU delay profile comprising the downlink transport delays and the uplink transport delays.

### CROSS-REFERENCE TO RELATED APPLICATIONS

This application claims the benefit of U.S. Provisional Patent Application Ser. No. 63/570,674, filed on Mar. 27, 2024, titled “EXTENDING eCPRI BASED DELAY MEASUREMENT PROCEDURE IN DISTRIBUTED ANTENNA SYSTEMS”, which is hereby incorporated herein by reference in its entirety.

### TECHNICAL FIELD

The present disclosure in general relates to wireless communication. More particularly, but not exclusively, the present disclosure relates to techniques for delay measurement in distributed antenna systems (DASs).

### BACKGROUND

For large and medium businesses, ubiquitous, multi-operator in-building wireless connectivity is increasingly critical for employee productivity, customer satisfaction and even brand reputation. For building owners and managers, excellent wireless connectivity can increase property value. For mobile network operators, neutral hosts and system integrators, the system must be economical to install and operate, and flexible to meet evolving mobile technologies and customer needs.

A distributed antenna system (DAS) is made of multiple connected components that together bring unobstructed RF signals indoors. The head-end or a remote radio head (RRH) is largely seen as the hub of the DAS and connects to a base transceiver station (BTS) or bi-directional amplifier (BDA) with a donor antenna (outdoor antenna), which is a transmitter of cellular signal to a BTS. In a modular DAS, the head-end can support many interchangeable frequency bands and is typically placed in a “telecom closet” or the deep recesses of a building where it isn't visible.

Remote Radio units (RRUs) are dispersed across different sectors of a deployment and connected to the head-end via fiber optic cables. Depending upon output transmission power of RRU, each RRU can be further connected to many serving antennas dispersed across the facility via coaxial cable to create a network of antennas and provide strong signal throughout the facility. Thus, DAS excels at bringing both coverage for multi-bands or multi-carriers.

Most modern deployments use an active DAS, which uses fiber-optic cable to distribute signals between RRH and RRUs. The active DAS is scalable and optimal for medium to large size buildings. Passive DAS is optimal for small to medium size buildings. Passive DAS has limited scalability, and signal strength depends on donor site input. However, it can be less costly to install. Passive DAS typically uses bi-directional amplifiers (BDA) to redistribute signal and amplifies and distributes wireless coverage from a nearest tower through a donor antenna.

In an Open Radio Access Network (O-RAN) based fronthaul network, Enhanced Common Public Radio Interface (eCPRI) measurement-based adaptive delay procedure supports delay measurement for one-to-one connection between distributed unit (DU) and RRU. eCPRI based dynamic delay measurement procedure in O-RAN considers downlink/uplink antenna delay as zero, and external antenna connection delay is not measurable. As the external antenna is connected directly to the radio unit, data transfer occurs using an I/O transfer protocol with a fixed delay.

However, in a DAS, where RRU will be connected to the RRH using switches causing change in transport delay. Therefore, there exists a need to extend the eCPRI measurement procedure between a RRH of a DAS and a plurality of RRUs in the DAS simulcast zones to support the requirements of DASs.

The information disclosed in this background section is only for enhancement of understanding of the general background of the disclosure and should not be taken as an acknowledgement or any form of suggestion that this information forms the prior art already known to a person skilled in the art.

### SUMMARY

One or more shortcomings discussed above are overcome, and additional advantages are provided by the present disclosure. Additional features and advantages are realized through the techniques of the present disclosure. Other aspects and aspects of the disclosure are described in detail herein and are considered a part of the disclosure.

According to an aspect of the present disclosure, methods, apparatus, and computer readable media are provided for extending eCPRI based delay measurement procedure in distributed antenna systems or an Open Radio Access Network (O-RAN) shared cell in Fronthaul Multiplexer (FHM) mode.

In one non-limiting aspect of the present disclosure, a method includes transmitting, by a distributed unit (DU), a plurality of delay measurement requests to a remote radio head (RRH) for uplink delay measurement and downlink delay measurement. Each of the plurality of downlink delay measurement requests comprises DU timing parameters. The RRH transmits a plurality of dummy packets of variable size along with RRH timing parameters, either to a plurality of remote radio units (RRUs) or a furthest and a nearest RRU among the plurality of RRUs, connected to the RRH in response to receiving the plurality of delay measurement requests. The method further includes receiving, from the RRH, a plurality of delay samples in response to the plurality of dummy packets being transmitted, determining, by the DU, downlink transport delays (T₁₂ₘₐₓ/T₁₂ₘᵢₙ) at least based on the plurality of delay samples and DU timing parameters, determining, by the DU, uplink transport delays (T₃₄ₘₐₓ/T₃₄ₘᵢₙ) at least based on the plurality of delay samples, and transmitting a DU delay profile to the RRH for adjustment a RRH transmission window and a RRH reception window, wherein the DU delay profile comprises the downlink transport delays (T₁₂ₘₐₓ/T₁₂ₘᵢₙ) and the uplink transport delays (T₃₄ₘₐₓ/T₃₄ₘᵢₙ).

In another non-limiting aspect of the present disclosure, a method includes transmitting a plurality of dummy packets of variable size, either to a plurality of remote radio units (RRUs) or a furthest and a nearest RRU among the plurality of RRUs, connected to a remote radio head (RRH), wherein each dummy data packet is transmitted along with RRH timing parameters, receiving a plurality of delay samples in response to the plurality of dummy packets being transmitted, either from each of the plurality of RRUs or the furthest and the nearest RRU, determining a plurality of adaptive delay parameters based on the plurality of delay samples and the RRH timing parameters, wherein the plurality of adaptive delay parameters comprises a maximum uplink antenna delay (T_{au_max}), a minimum uplink antenna delay (T_{au_min}), a maximum downlink antenna delay (T_{da_max}), and a minimum downlink antenna delay (T_{da_min}), and storing the plurality of adaptive delay parameters with the RRH.

In yet another non-limiting aspect of the present disclosure, an apparatus comprises a memory, at least one transceiver, and at least one processor communicatively coupled with the memory and the at least one transceiver. The at least one processor is configured to transmit a plurality of delay measurement requests to a remote radio head (RRH) for uplink delay measurement and downlink delay measurement. Each of the plurality of downlink delay measurement requests comprises DU timing parameters. The RRH transmits a plurality of dummy packets of variable size along with RRH timing parameters, either to a plurality of remote radio units (RRUs) or a furthest and a nearest RRU among the plurality of RRUs, connected to the RRH in response to receiving the plurality of delay measurement requests. The at least one processor is configured to receive a plurality of delay samples in response to the plurality of dummy packets being transmitted, determine downlink transport delays (T₁₂ₘₐₓ/T₁₂ₘᵢₙ) at least based on the plurality of delay samples and DU timing parameters, determine uplink transport delays (T₃₄ₘₐₓ/T₃₄ₘᵢₙ) at least based on the plurality of delay samples, and transmit a distributed unit (DU) delay profile to the RRH for adjustment a RRH transmission window and a RRH reception window. The DU delay profile comprises the downlink transport delays (T₁₂ₘₐₓ/T₁₂ₘᵢₙ) and the uplink transport delays (T₃₄ₘₐₓ/T₃₄ₘᵢₙ).

In yet another non-limiting aspect of the present disclosure, an apparatus comprises a memory, at least one transceiver, and at least one processor communicatively coupled with the memory and the at least one transceiver. The at least one processor is configured to transmit a plurality of dummy packets of variable size, either to a plurality of remote radio units (RRUs) or a furthest and a nearest RRU among the plurality of RRUs, connected to a remote radio head (RRH). Each dummy data packet is transmitted along with RRH timing parameters. The at least one processor is further configured to receive a plurality of delay samples in response to the plurality of dummy packets being transmitted, either from each of the plurality of RRUs or the furthest and the nearest RRU and determine a plurality of adaptive delay parameters based on the plurality of delay samples and the RRH timing parameters. The plurality of adaptive delay parameters comprises a maximum uplink antenna delay (T_{au_max}), a minimum uplink antenna delay (T_{au_min}), a maximum downlink antenna delay (T_{da_max}), and a minimum downlink antenna delay (T_{da_min}). The at least one processor is configured to store the plurality of adaptive delay parameters with the RRH.

In yet another non-limiting aspect of the present disclosure, a non-transitory computer readable media stores one or more instructions which, when executed by at least one processor, causes the at least one processor to perform operations of transmitting, by a distributed unit (DU), a plurality of delay measurement requests to a remote radio head (RRH) for uplink delay measurement and downlink delay measurement. Each of the plurality of downlink delay measurement requests comprises DU timing parameters. The RRH transmits a plurality of dummy packets of variable size along with RRH timing parameters, either to a plurality of remote radio units (RRUs) or a furthest and a nearest RRU among the plurality of RRUs, connected to the RRH, in response to receiving the plurality of delay measurement requests. The one or more instructions further causes the at least one processor to perform operations of receiving, from the RRH, a plurality of delay samples in response to the plurality of dummy packets being transmitted, determining, by the DU, downlink transport delays (T₁₂ₘₐₓ/T₁₂ₘᵢₙ) at least based on the plurality of delay samples and DU timing parameters, determining, by the DU, uplink transport delays (T₃₄ₘₐₓ/T₃₄ₘᵢₙ) at least based on the plurality of delay samples, and transmitting a DU delay profile to the RRH for adjustment a RRH transmission window and a RRH reception window, wherein the DU delay profile comprises the downlink transport delays (T₁₂ₘₐₓ/T₁₂ₘᵢₙ) and the uplink transport delays (T₃₄ₘₐₓ/T₃₄ₘᵢₙ).

In yet another non-limiting aspect of the present disclosure, a non-transitory computer readable media stores one or more instructions which, when executed by at least one processor, cause the at least one processor to perform operations of transmitting a plurality of dummy packets of variable size, either to a plurality of remote radio units (RRUs) or a furthest and a nearest RRU among the plurality of RRUs, connected to a remote radio head (RRH). Each dummy data packet is transmitted along with RRH timing parameters. The one or more instructions further causes the at least one processor to perform operations of receiving a plurality of delay samples in response to the plurality of dummy packets being transmitted, either from each of the plurality of RRUs or the furthest and the nearest RRU, determining a plurality of adaptive delay parameters based on the plurality of delay samples and the RRH timing parameters, wherein the plurality of adaptive delay parameters comprises a maximum uplink antenna delay (T_{au_max}), a minimum uplink antenna delay (T_{au_min}), a maximum downlink antenna delay (T_{da_max}), and a minimum downlink antenna delay (T_{da_min}), and storing the plurality of adaptive delay parameters with the RRH.

The foregoing summary is illustrative only and is not intended to be in any way limiting. In addition to the illustrative aspects, aspects, and features described above, further aspects, aspects, and features will become apparent by reference to the drawings and the following detailed description.

### BRIEF DESCRIPTION OF DRAWINGS

Further aspects and advantages of the present disclosure will be readily understood from the following detailed description with reference to the accompanying drawings. Reference numerals have been used to refer to identical or functionally similar elements. The figures together with a detailed description below, are incorporated in and form part of the specification, and serve to further illustrate the aspects and explain various principles and advantages, in accordance with the present disclosure wherein:

FIG. 1A shows an exemplary architecture 100 illustrating communication setup between DU and plurality of RRUs in a distributed antenna system (DAS), in accordance with some aspects of the present disclosure.

FIG. 1B shows definition of reference points for delay management between DU and RRH, in accordance with some aspects of the present disclosure;

FIG. 2A shows an eCPRI based downlink delay measurement procedure, in accordance with some aspects of the present disclosure.

FIG. 2B shows an eCPRI based uplink delay measurement procedure, in accordance with some aspects of the present disclosure.

FIG. 3A shows downlink delay management in a distributed antenna system (DAS), in accordance with some aspects of the present disclosure.

FIG. 3B shows uplink delay management in a distributed antenna system (DAS), in accordance with some aspects of the present disclosure.

FIG. 4 shows a high-level block diagram of an apparatus 400 for extending eCPRI based delay measurement procedure in distributed antenna systems (DASs), in accordance with some aspects of the present disclosure.

FIG. 5 shows a flowchart of an exemplary method 500 of extending eCPRI based delay measurement procedure in distributed antenna systems (DASs), in accordance with some aspects of the present disclosure.

FIG. 6 shows a flowchart of an exemplary method 600 of extending eCPRI based delay measurement procedure in distributed antenna systems (DASs), in accordance with some aspects of the present disclosure.

FIG. 7 shows a flowchart of another exemplary method 700 for dynamically determining a furthest and a nearest remote radio unit (RRU) in a distributed antenna system (DAS), in accordance with some aspects of the present disclosure.

It should be appreciated by those skilled in the art that any block diagrams herein represent conceptual views of the illustrative systems embodying the principles of the present disclosure. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any aspect or implementation of the present disclosure described herein as “exemplary” is not necessarily to be construed as preferred or advantageous over other aspects.

While the disclosure is susceptible to various modifications and alternative forms, specific aspects thereof have been shown by way of example in the drawings and will be described in detail below. It should be understood, however, that it is not intended to limit the disclosure to the particular form disclosed, but on the contrary, the disclosure is to cover all modifications, equivalents, and alternatives falling within the spirit and the scope of the disclosure.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus preceded by “comprises . . . a” does not, without more constraints, preclude the existence of other elements or additional elements in the system.

The terms like “at least one” and “one or more” may be used interchangeably throughout the description. The terms like “a plurality of” and “multiple” may be used interchangeably throughout the description. The terms like “distributed unit”, “distributed unit entity” and “DU” may be used interchangeably throughout the description. The terms like “remote radio head” and “RRH” may be used interchangeably throughout the description. The terms like “remote radio units”, “remote radio unit” and “RRU” may be used interchangeably throughout the description. The terms like “distributed antenna system” and “DAS” may be used interchangeably throughout the description.

In the following detailed description of the aspects of the disclosure, reference is made to the accompanying drawings that form a part hereof, and in which are shown by way of illustration of specific aspects in which the disclosure may be practiced. These aspects are described in sufficient detail to enable those skilled in the art to practice the disclosure, and it is to be understood that other aspects may be utilized and that changes may be made without departing from the scope of the present disclosure. The following description is, therefore, not to be taken in a limiting sense. In the following description, well known functions or constructions are not described in detail since they would obscure the description with unnecessary detail.

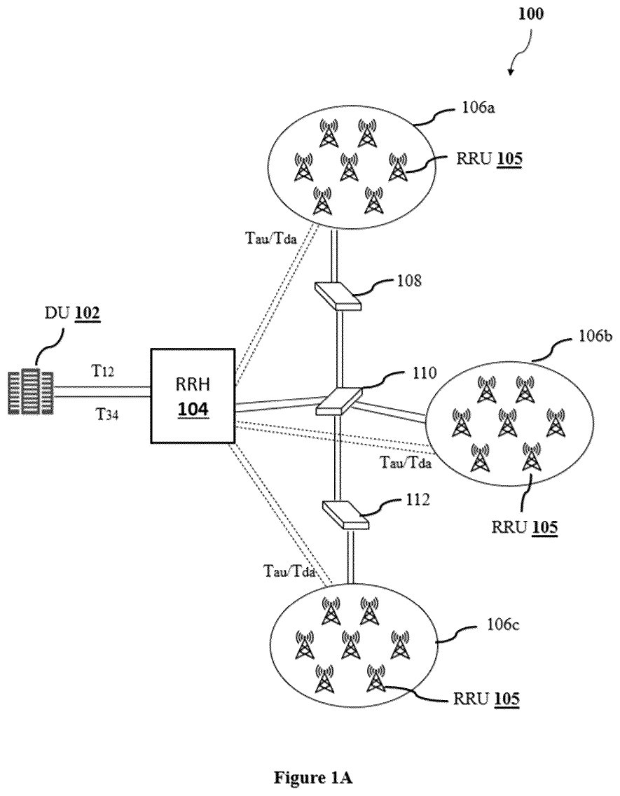

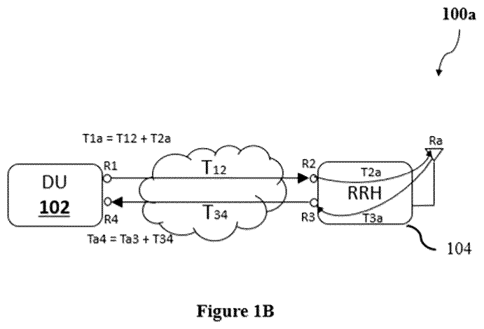

Referring now to FIG. 1A which shows an exemplary architecture 100 illustrating communication setup between DU and plurality of RRUs in a distributed antenna system (DAS), in accordance with some aspects of the present disclosure. The architecture 100 shows a fronthaul connection between DU and the plurality of RRUs. The architecture 100 comprises a distributed unit (DU) 102, a remote radio head (RRH) 104, a plurality of remote radio units (RRUs) 105. In one non-limiting aspect, the RRH 104 may be a Fronthaul Multiplexer (FHM) Unit in Open Radio Access Network (O-RAN) shared cell in Fronthaul Multiplexer (FHM) mode.

The plurality of RRUs 105 may be dispersed across different sectors/zones/cells 106a, 106b, 106c also known as DAS simulcast zones. Each such sector/zone/cell 106a, 106b, 106c may cover a respective predefined geographical area. The plurality of RRUs 105 of the zones 106a, 106b, 106c may be communicatively coupled to the RRH 104 through one or more switches 108, 110, and 112 and fiber optic cables. The one or more switches 108, 110, and 112 may comprise at least one aggregation switch 110 and one or more access switches 108, 112. As shown in FIG. 1A, the RRH 104 may be coupled to RRUs 105 of the DAS simulcast zone 106a through the aggregation switch 110 and the access switch 108. Similarly, the RRH 104 may be coupled to RRUs 105 of the DAS simulcast zone 106b through the aggregation switch 110, and similarly the RRH 104 may be further coupled to RRUs 105 of the DAS simulcast zone 106c through the aggregation switch 110 and the access switch 112.

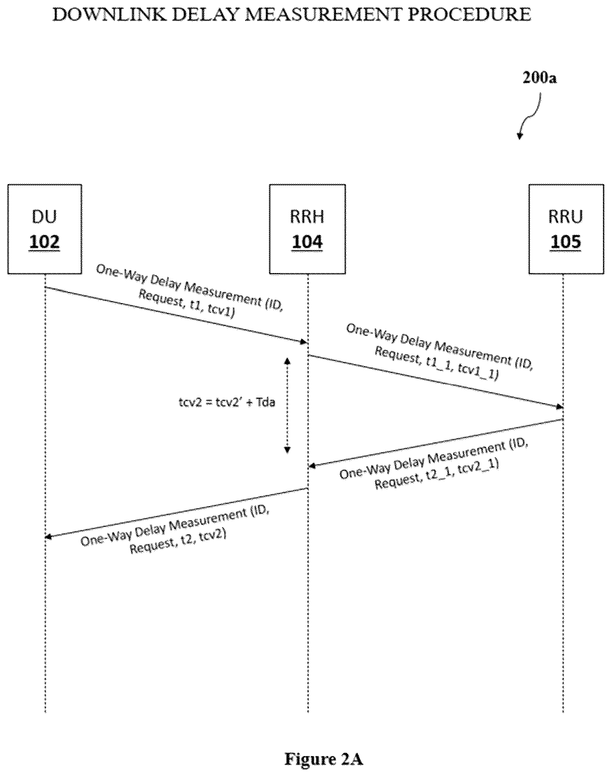

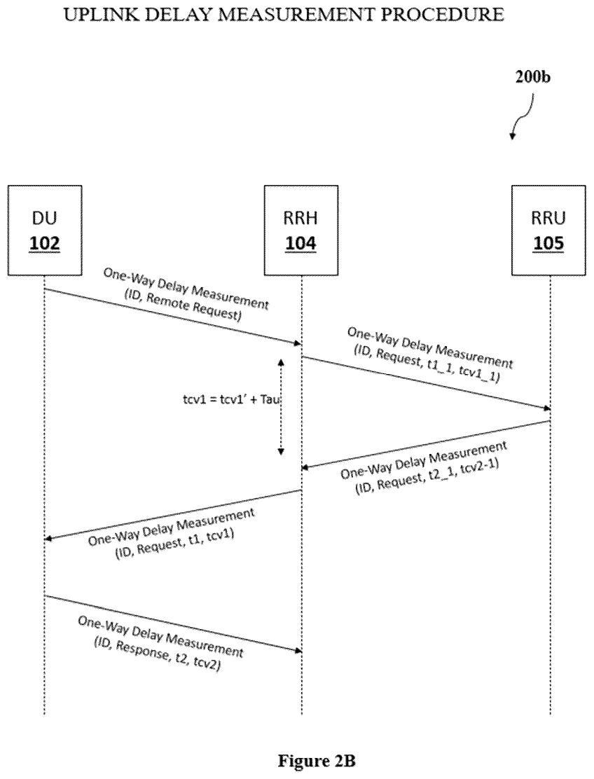

Aspects of the present invention extends the eCPRI delay measurement procedure by considering proprietary, eCPRI, or any other interface between the RRH 104 and RRUs 105 to measure the delay and convert the measurement in eCPRI format by including the delay between the RRH 104 and RRUs 105 as a part of the compensation value while responding from the RRH 104 to DU 102 (which is discussed in detail with respect to FIG. 2A and FIG. 2B below). Such consideration makes the entire delay measurement in uplink and downlink direction more precise, thereby accommodating the existing procedure of delay management by making RRH to RRU delay as part of measured T12 and T34 delay to improve the synchronization between DU 102 and RRUs 105.

As shown in FIG. 1B, the reference points (as per eCPRI) for DU and RRH may comprise R1 as transmit interface for DU and R4 as receive interface at DU, R2 as receive interface for RRH and R3 as transmit interface for RRH. When an external antenna is used with a cable to connect to the RRH, then the RRH connector to the external antenna port may be assumed as Ra. As fixed timing at Ra is still required. Therefore, Ra is used as a reference point for delay management in the eCPRI model and transmission and reception at the reference points shall be measured relative to Ra.

The transmission delay between the DU 102 and the RRH 104 will be T₁₂ (downlink) and T₃₄ (uplink). The transmission delay encompasses only the time from when a bit leaves the sender i.e., DU 102 having the transmit interface (R1) and the receive interface (R3) and until it is received at the receiver i.e., RRH 104 having the receive interface (R2) and the transmit interface (R4). In other words, T₁₂ indicates a time delay in DL direction between transmit interface R1 (of DU) and receive interface R2 (of RRH), when the data is transmitted from the DU and received at the RRH, whereas T₃₄ indicates a time delay in UL direction between receive interface R3 (of RRH) and transmit interface R4 (of DU), when the data is transmitted from the RRH and received at the DU. In one non-limiting aspect of the present disclosure, the reference point of the transmit and the receive interface (R1, R2, R3, R4) between the DU 102 and the RRH 104 may be as per precision time protocol (PTP) protocol as described in the eCPRI specification. However, the reference point of the transmit and the receive interface (R1, R2, R3, R4) between the DU 102 and the RRH 104 is not limited to above example and may be at MAC layer or Ethernet layer interface of the DU 102 and the RRH 104 depending on the type of vendor selected for DU 102 and the RRH 104. In an ethernet transport network, these delays may not be constant due to switching delays (i.e., PDV). To account for this, transport delay shall be considered as a range with upper and lower bounds i.e., the maximum transport delay and the minimum transport delay. The downlink transport delay may have lower/upper bound values T₁₂ₘᵢₙ/T₁₂ₘₐₓ and the uplink transport delay may have lower/upper values T₃₄ₘᵢₙ/T₃₄ₘₐₓ.

As the RRUs 105 being connected to the RRH 104 using switches such as aggregation switch 110 and the access switches 108, 112 (as shown in FIG. 1A), the transport delay may introduce the antenna delay parameters. The antenna delay parameter in the uplink may be denoted as Tₐᵤ and the antenna delay parameter in the downlink may be denoted as T_{da}. The calculation of the antenna delay parameter is further discussed in more detail in below aspects.

The plurality of RRUs 105 may be configured to provide wireless services to one or more user equipment (UE) present in its vicinity. The one or more UEs may be any mobile or non-mobile computing device including, but not limited to, a phone (e.g., a cellular phone or smart phone), a pager, a laptop computer, a desktop computer, a wireless handset, a portable communication device, a portable computing device (e.g., a personal data assistant), an entertainment device (e.g., a music or video device, or a satellite radio), a global positioning system device, or any other suitable computing device including a wired or wireless communications interface.

In an aspect, the DU 102 may be coupled to a central unit (CU) and may be configured to communicate with a core network of an associated wireless operator using an appropriate backhaul network (typically, a public wide area network such as the Internet). In one non-limiting aspect of the present disclosure, the core network may be a 5G core network in a standalone mode of deployment. The 5G core network may utilize cloud-aligned, service-based architecture that spans across all 5G functions and interactions including authentication, security, session management etc. The 5G core network may further emphasize network function virtualization (NFV) as an integral design concept with virtualized software functions.

In another non-limiting aspect, the core network may be a long-term evolution evolved packet core (LTE EPC) network in a non-standalone mode of deployment where services are provided using previous generation infrastructure (e.g., using existing LTE Evolved Packet Core (EPC)). The present disclosure may also be applicable for standalone and/or non-standalone modes of deployments or other modes of deployments which may be developed in the future.

In one implementation (as shown in FIG. 1A), each RRUs 105 may be remotely located from the DU 102 serving it. Each RRU 105 may be communicatively coupled to a DU 102, which is serving it via a fronthaul network which may comprise a private network, and/or the Internet, but not limited thereto. Also, each RRU 105 may include or may be coupled to a respective set of one or more antennas via which downlink (DL) RF signals are radiated to the UEs served within the zones 106a, 106b, 106c and via which uplink (UL) RF signals transmitted by the UEs are received.

Each of the DU 102, RRH 104, and RRU 105 and any of the specific features described herein can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.).

Moreover, of the DU 102, RRH 104, and RRU 105 may be implemented as a physical network function (PNF) (for example, using dedicated physical programmable devices and other circuitry) and/or a virtual network function (VNF) (for example, using one or more general purpose servers (possibly with hardware acceleration) in a scalable cloud environment and in different locations within an operator's network (for example, in the operator's “edge cloud” or “central cloud”). Each VNF can be implemented using hardware virtualization, operating system virtualization (also referred to as containerization), and application virtualization as well as various combinations of two or more the preceding. Where containerization is used to implement a VNF, it may also be referred to as a “containerized network function” (CNF).

Referring now to FIG. 2A which shows an eCPRI based delay measurement procedure for calculating downlink delay parameters between DU 102 and RRU 105 of DAS simulcast zones 106a, 106b, 106c via RRH 104. Firstly, a downlink delay measurement request message is transmitted from the DU 102 to the RRH 104. The RRH 104 may initiate a delay measurement procedure between the RRH 104 and RRUs 105, accordingly. The downlink delay measurement request message may include a dummy packet and DU timing parameters. The DU timing parameters may comprise a DU timestamp value (t₁) and a DU compensation time (t_{cv1}). The RRH 104 may receive the downlink delay measurement request and in response may transmit the dummy packet to the RRUs 105 along with RRH timing parameters. The RRH timing parameters may comprise a RRH timestamp value (t₁₋₁) and a RRH compensation time (t_{cv1-1}). In one non-limiting aspect of the present disclosure, the RRH 104 may transmit the dummy packet to a plurality of RRUs 105 of each DAS simulcast zone 106a, 106b, 106c.

However, transmitting such dummy packet to a plurality of RRUs 105 of each DAS simulcast zone 106a, 106b, 106c, processing all the delay samples received from the plurality of RRUs 105, and providing updated delay samples to DU 102 with timing parameters of RRH 104 for the calculation of the antenna delay parameters/DU delay profile may require considerable time which may increase the latency. Thus, in order to reduce the processing of all the delay samples received from the plurality of RRUs 105, the present disclosure aims to consider only the furthest RRU and the nearest RRU among the plurality of RRUs 105 as it will automatically cover the maximum and the minimum value of the antenna delay parameters. This optimization of collecting only the delay samples from the furthest RRU and the nearest RRU for measuring the delay profiles/antenna delay parameters only with respect to the furthest RRU and the nearest RRU reduces the unnecessary processing of the delay samples received from the plurality of RRUs 105.

The RRH 104 may now transmit the dummy packet to a furthest RRUs 105 and a nearest RRU 105 of each DAS simulcast zone 106a, 106b, 106c. In yet another non-limiting aspect of the present disclosure, the RRH 104 may transmit the dummy packet to a furthest RRUs 105 and a nearest RRU 105 of the plurality of RRUs 105. The RRU/furthest and the nearest RRU 105 may transmit a delay sample in response to reception of the dummy packet. The delay sample may comprise a RRU timestamp value (t₂₋₁) and a RRU compensation time (t_{cv2-1}). The RRH 104 may determine the RRH compensation time (t_{cv2}) based on the delay sample received from the furthest and the nearest RRU 105, the DU timing parameters, and the RRH timing parameters, and may transmit the RRH compensation time (t_{cv2}) to the DU 102 along with RRH time stamp value (t₂) in the form of delay sample. The DU 102 considers the delay sample is received from the RRH 104. The RRH compensation time (t_{cv2}) may comprise ethernet packet processing time/packetization time/packetization delay of RRH 104 along with the downlink antenna delay parameter (T_{da}) as shown in below equations.

$${T}_{da} = ( {t}_{2 - 1} + {t}_{cv 2 - 1} ) - ( {t}_{1 - 1} + {t}_{cv 1 - 1} ) \qquad ( 1 )$$

$${t}_{cv 2} = {t}_{cv 2} ’ + {T}_{da} \qquad ( 2 )$$

where, t_{cv2}′ ethernet packet processing time/packetization time/packetization delay of RRH 104, and T_{da} is the downlink antenna delay parameter. The RRH compensation time (t_{cv2}) may comprise a maximum value of T_{da} based on the delay sample received from the furthest RRU and a minimum value of T_{da} based on the delay sample received from the nearest RRU.

The compensation time may vary based on the reference point of the transmit and the receive interface of the respective entities (DU, RRH, and RRU), which may vary from one vendor to another. Further, if the precision time protocol (PTP) is not capable of using a one-step delay measurement process as discussed above, then a two-step delay measurement process may be followed for carrying out the above measurements.

In the first solution, the DU 102 may then determine downlink transport delays (T₁₂ₘₐₓ/T₁₂ₘᵢₙ) based on the delay sample received from the RRH 104 and DU timing parameters. Thus, the RRH compensation time (t_{cv2}) affects T₁₂ calculation and therefore downlink antenna delay parameter (T_{da}) automatically becomes part of the T₁₂ measured by the DU 102. However, the DU 102 is not aware of the downlink antenna delay parameter (T_{da}) being part of the downlink transport delays (T₁₂ₘₐₓ/T₁₂ₘᵢₙ), in the first solution. In one non-limiting aspect, the above process is repeated using a plurality of dummy packets of variable size to determine a maximum and minimum downlink antenna delay parameters. The DU 102 and the RRH 104 may update their respective transmission window based on the downlink transport delays (T₁₂ₘₐₓ/T₁₂ₘᵢₙ) (DU delay profile) in the downlink. The first solution enables minimal change in O-RAN Control, User and Synchronization Plane (CUS) specification as the antenna delay parameters are included in the downlink transport delay T₁₂.

In one non-limiting aspect of the present disclosure, the transmission and reception between the RRH 104 and RRU 105 may be carried out using any proprietary communication protocol known to a person skilled in the art. The proprietary communication protocol may be used in case where eCPRI delay measurement procedure is not supported between the RRH 104 and RRU 105 of the DAS simulcast zones 106a, 106b, 106c.

In the second solution, of the present disclosure, the RRH 104 may determine the downlink antenna delay parameter (T_{da}) using the equation (1) with or without receiving the downlink delay measurement request message from the DU 102. The RRH 104 may measure and determine the downlink delay parameter between the RRH 104 and the RRU 105 using the eCPRI delay measurement procedure discussed above or using any other proprietary communication protocol known to a person skilled in the art. In such a scenario, the RRH 104 may operate as master and the RRU 105 may operate as slave to the master RRH 104. The RRH 104 may store the downlink antenna delay parameter (T_{da}) in a memory container and may transmit/forward the memory container comprising the determined downlink antenna delay parameter (T_{da}) to the DU 102 as an adaptive delay parameter for adjusting a DU transmission window. The DU 102 in the second solution supports and is aware of the adaptive delay parameter (T_{da}) and may update its respective memory container value of T_{da} based on the memory container of the RRH 104.

In this second solution, the downlink antenna delay parameters are introduced to the DU 102 through an updated O-RAN delay management yang model, when the DU 102 supports adaptive delay parameters. The updated O-RAN delay management yang model comprises the adaptive delay parameters containers that are exchanged between the DU 102 and RRH 104 for adjusting their respective transmission and reception window.

Referring now to FIG. 2B which shows an eCPRI based delay measurement procedure for calculating uplink delay parameters between DU 102 and RRU 105 of DAS simulcast zones 106a, 106b, 106c via RRH 104. In the first solution, uplink delay measurement remote request is transmitted from the DU 102 to the RRH 104 for uplink delay measurement. The RRH 104 receives the uplink delay measurement remote request and transmits a dummy packet to the RRU 105 along with RRH timing parameters. The RRH timing parameters may comprise a RRH timestamp value (t₁₋₁) and a RRH compensation time (t_{cv1-1}). In one non-limiting aspect of the present disclosure, the RRH 104 may transmit the dummy packet to a plurality of RRUs 105 of each DAS simulcast zone 106a, 106b, 106c.

However, transmitting such dummy packet to a plurality of RRUs 105 of each DAS simulcast zone 106a, 106b, 106c, processing all the delay samples received from the plurality of RRUs 105, and providing updated delay samples to DU 102 with timing parameters of RRH 104 for the calculation of the antenna delay parameters/DU delay profile may require considerable time which may increase the latency. Thus, in order to reduce the processing of all the delay samples received from the plurality of RRUs 105, the present disclosure aims to consider only the furthest RRU and the nearest RRU among the plurality of RRUs 105 as it will automatically cover the maximum and the minimum value of the antenna delay parameters. This optimization of collecting only the delay samples from the furthest RRU and the nearest RRU for measuring the antenna delay parameters only with respect to the furthest RRU and the nearest RRU reduces the unnecessary processing of the delay samples received from the plurality of RRUs 105.

The RRH 104 may transmit the dummy packet to the RRUs 105 of each DAS simulcast zone 106a, 106b, 106c. In yet another non-limiting aspect of the present disclosure, the RRH 104 may transmit the dummy packet to a furthest and a nearest RRUs 105 of the plurality of RRUs 105. The RRUs/furthest and nearest RRU 105 may transmit a delay sample in response to reception of the dummy packet. The delay sample may comprise a RRU timestamp value (t₂₋₁) and a RRU compensation time (t_{cv2-1}). The RRH 104 may determine RRH compensation time (t_{cv1}) based on the delay sample received from the furthest and the nearest RRU 105 and RRH timing parameters. The RRH 104 may transmit the RRH compensation time (t_{cv1}) to the DU 102 along with the RRH time stamp (t₁) in the form of delay sample. The DU 102 considers the delay sample is received from the RRH 104. The RRH compensation time (t_{cv1}) may comprise ethernet packet processing time/packetization time/packetization delay of RRH 104 along with the uplink antenna delay parameter (Tₐᵤ) as shown in below equations.

$${T}_{au} = ( {t}_{2 - 1} + {t}_{cv 2 - 1} ) - ( {t}_{1 - 1} + {t}_{cv 1 - 1} ) \qquad ( 3 )$$

$${t}_{cv 1} = {t}_{cv 1} ’ + {T}_{au} \qquad ( 4 )$$

where, t_{cv1}′ ethernet packet processing time/packetization time/packetization delay of RRH 104, and Tₐᵤ is the uplink antenna delay parameter. The RRH compensation time (t_{cv1}) may comprise a maximum value of Tₐᵤ based on the delay sample received from the furthest RRU and a minimum value of Tₐᵤ based on the delay sample received from the nearest RRU.

The compensation time may vary based on the reference point of the transmit and the receive interface of the respective entities (DU, RRH, and RRU), which may vary from one vendor to another. Further, if the precision time protocol (PTP) is not capable of using the one-step delay measurement process as discussed above, then a two-step delay measurement process may be followed for carrying out the above measurements.

In the first solution, the DU 102 may then determine uplink transport delays (T₃₄ₘₐₓ/T₃₄ₘᵢₙ) based on the delay sample received from the RRH 104 and the DU timing parameters. Thus, the RRH compensation time (t_{cv1}) affects T₃₄ calculation and therefore the uplink antenna delay parameter (Tₐᵤ) automatically becomes part of the measured T₃₄ measured by the DU 102. However, the DU 102 is not aware of the uplink antenna delay parameter (Tₐᵤ) being part of the downlink transport delays (T₃₄ₘₐₓ/T₃₄ₘᵢₙ), in the first solution. In one non-limiting aspect, the above process is repeated using a plurality of dummy packets of variable size to determine a maximum and a minimum uplink antenna delay. The DU 102 and the RRH 104 may update their respective reception window based on the uplink transport delays (T₃₄ₘₐₓ/T₃₄ₘᵢₙ) (DU delay profile) in the downlink. The first solution enables minimal change in O-RAN Control, User and Synchronization Plane (CUS) specification as the antenna delay parameters are included in the uplink transport delay T₃₄.

In one non-limiting aspect of the present disclosure, the transmission and reception between the RRH 104 and RRU 105 may be carried out using any proprietary communication protocol known to a person skilled in the art. The proprietary communication protocol may be used in cases where eCPRI delay measurement procedure is not supported between the RRH 104 and RRU 105 of the DAS simulcast zones 106a, 106b, 106c.

In the second solution, the RRH 104 may determine the uplink delay parameter (Tₐᵤ) using the equation (3) with or without receiving the uplink delay measurement remote request from the DU 102. The RRH 104 may measure and determine the uplink delay parameter between the RRH 104 and the RRU 105 using the eCPRI delay measurement procedure as discussed above or using any other proprietary communication protocol known to a person skilled in the art. In such a scenario, the RRH 104 may operate as master and the RRU 105 may operate as slave to the master RRH 104. The RRH 104 may store the uplink delay parameter (Tₐᵤ) in a memory container and may transmit/forward the memory container comprising the determined uplink delay parameter (Tₐᵤ) to the DU 102 as an adaptive delay parameter for adjusting a DU reception window. The DU 102 in the second solution supports and is aware of the adaptive delay parameter (Tₐᵤ) and may update its respective memory container value of Tₐᵤ based on the memory container of the RRH 104.

In the second solution, the uplink antenna delay parameters are introduced to the DU 102 through an updated O-RAN delay management yang model, when the DU 102 supports adaptive delay parameters. The updated O-RAN delay management yang model comprises the adaptive delay parameters containers that are exchanged between the DU 102 and RRH 104 for adjusting their respective transmission and reception window.

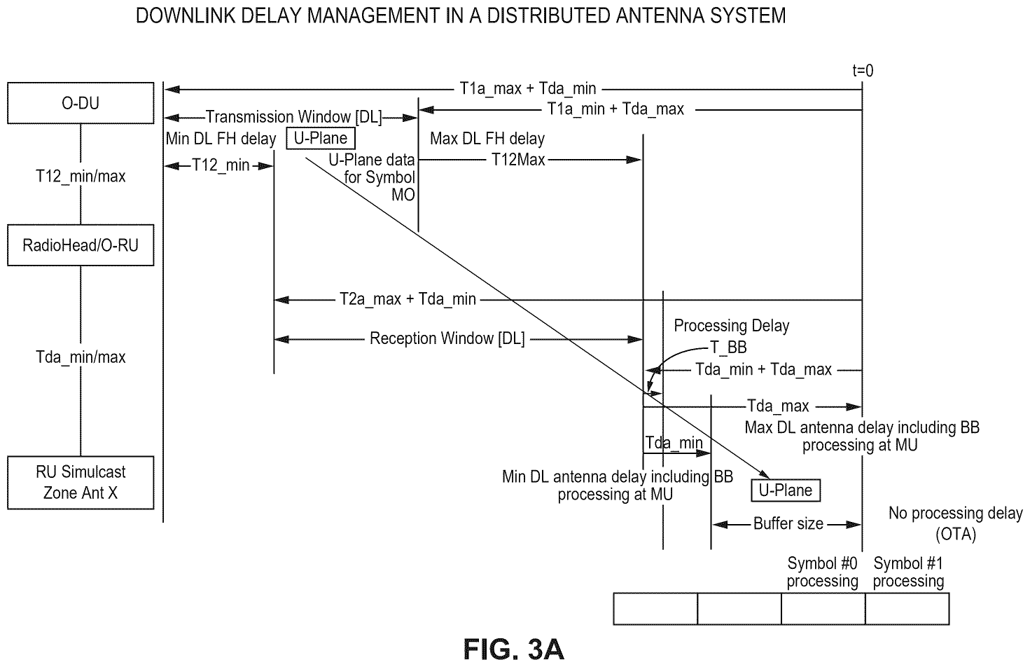

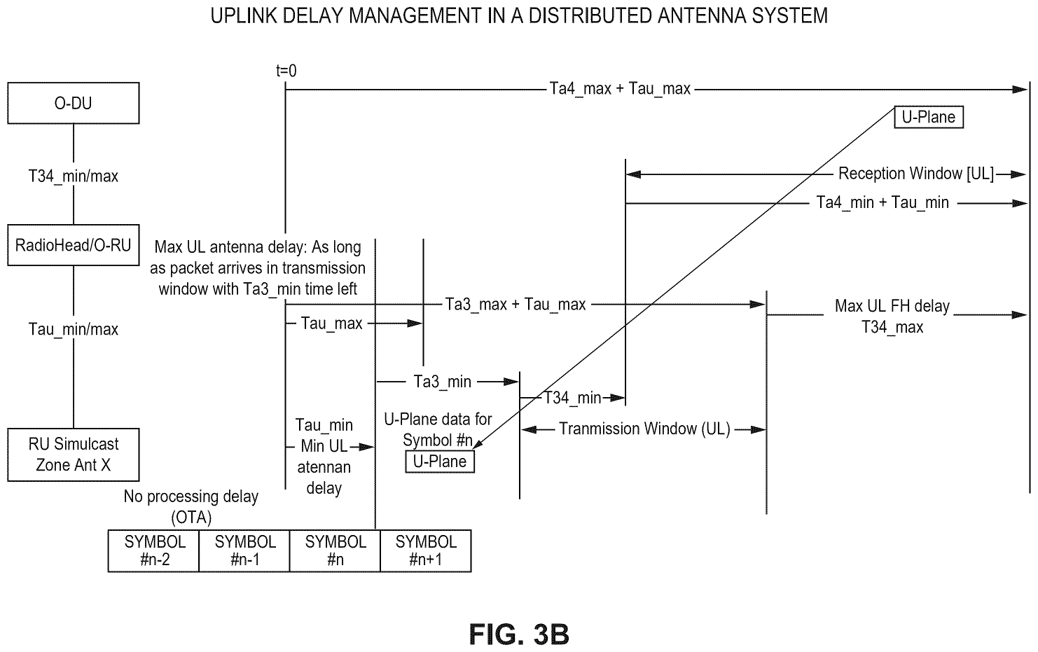

Referring now to FIG. 3A which shows downlink delay management in a distributed antenna system (DAS), in accordance with some aspects of the present disclosure. The minimum downlink fronthaul (FH) delay for data transmission in the U-plane between DU and RRH is T_{12_min} and the maximum downlink FH delay for data transmission in the U-plane between DU and RRH is T_{12_max}. The minimum downlink antenna delay parameter for data transmission in U-plane between RRH and RRU of the DAS simulcast zone is T_{da_min} and the maximum downlink antenna delay parameter for data transmission in U-plane between RRH and RRU of the DAS simulcast zone is T_{da_max}. The latency parameter may further include the baseband processing delay T_{_BB} which may be required by RRH for baseband processing of the data packet received at RRH. The minimum latency measured between receive port R2 of RRH to transmission over the air and towards RRU is T_{2a_min} and the maximum latency measured between receive port R2 of RRH to transmission over the air and towards RRU is T_{2a_max} (as shown in FIG. 1B). Thus, the minimum latency between receive port R2 of RRH and RRU in downlink is T_{2a_min}+T_{da_max} and the maximum latency between receive port R2 of RRH and RRU in downlink is T_{2a_max}+T_{da_min}. The downlink delay characteristics may be made available to the DU from the RRH as shown in below table 1.

TABLE 1

| | | U-Plane | C-Plane |
|---|---|---|---|
| Downlink | Minimum | T₂ₐ_{_{—}}ₘᵢₙ_{_{—}}ᵤₚ = | T₂ₐ_{_{—}}ₘᵢₙ_{_{—}}_{cp}_{_{—}}_{dl} = |
| | | MAX(T₂ₐ_{_{—}}ₘᵢₙ_{_{—}}ᵤₚⱼ) | MAX(T₂ₐ_{_{—}}ₘᵢₙ_{_{—}}_{cp}_{_{—}}_{dlj}) |
| | Maximum | T₂ₐ_{_{—}}ₘₐₓ_{_{—}}ᵤₚ = | T₂ₐ_{_{—}}ₘₐₓ_{_{—}}_{cp}_{_{—}}_{dl} = |
| | | MIN(T₂ₐ_{_{—}}ₘₐₓ_{_{—}}ᵤₚⱼ) | MIN(T₂ₐ_{_{—}}ₘₐₓ_{_{—}}_{cp}_{_{—}}_{dlj}) |
| | Minimum | T_{da}_{_{—}}ₘᵢₙ = MIN(T_{daj}) | |
| | Maximum | T_{da}_{_{—}}ₘₐₓ = MAX(T_{daj}) | |

Based on the above-mentioned latency parameters, the DU may update the transmit boundary relationship as shown in below table 2.

TABLE 2

| | | | Updated DU transmit |
|---|---|---|---|
| DU Timing | | Parameter | boundary relationship |
| Downlink | No earlier than | T₁ₐₘₐₓ | T₁ₐₘₐₓ ≤ (T₂ₐₘₐₓ + |
| | | | T_{damin}) + T₁₂ₘᵢₙ |
| (Transmit) | No later than | T₁ₐₘᵢₙ | T₁ₐₘᵢₙ ≥ (T₂ₐₘᵢₙ + |
| | | | T_{damax}) + T₁₂ₘₐₓ |

The above may be latency parameters that may be used to adjust the transmission/reception window position of O-DU (in time).

Referring now to FIG. 3B which shows uplink delay management in a distributed antenna system (DAS), in accordance with some aspects of the present disclosure. The minimum uplink fronthaul (FH) delay for data transmission in U-plane from RRH to DU is T_{34_min} and the maximum uplink FH delay for data transmission in U-plane between from RRH to DU is T_{34_max}. The minimum uplink antenna delay parameter for data transmission in the U-plane between RRU and RRH is T_{au_min} and the maximum uplink antenna delay parameter for data transmission in the U-plane between RRU and RRH is T_{au_max}. The minimum latency measured between transmit port R3 of RRH to transmission over the air and towards RRU is T_{a3_min} and the maximum latency measured between transmit port R3 of RRH to transmission over the air and towards RRU is T_{a3_max} (as shown in FIG. 1B). Thus, the minimum latency between transmit port R3 of RRH and RRU in uplink is T_{a3_min}+T_{au_min} and the maximum latency between transmit port R3 of RRH and RRU in uplink is T_{a3_max}+T_{au_max}. The uplink delay characteristics may be made available to the DU from the RRH as shown in below table 3.

TABLE 3

| | | U-Plane | C-Plane |
|---|---|---|---|
| Uplink | Minimum | Tₐ₃_{_{—}}ₘᵢₙ = | T₂ₐ_{_{—}}ₘᵢₙ_{_{—}}_{cp}_{_{—}}ᵤₗ = |
| | | MIN(Tₐ₃_{_{—}}ₘᵢₙⱼ) | MAX(T₂ₐ_{_{—}}ₘᵢₙ_{_{—}}_{cp}_{_{—}}ᵤₗⱼ) |
| | Maximum | Tₐ₃_{_{—}}ₘₐₓ = | T₂ₐ_{_{—}}ₘₐₓ_{_{—}}_{cp}_{_{—}}ᵤₗ = |
| | | MAX(Tₐ₃_{_{—}}ₘₐₓⱼ) | MIN(T₂ₐ_{_{—}}ₘₐₓ_{_{—}}_{cp}_{_{—}}ᵤₗⱼ) |
| | Minimum | Tₐᵤ_{_{—}}ₘᵢₙ = MIN(Tₐᵤⱼ) | |
| | Maximum | Tₐᵤ_{_{—}}ₘₐₓ = MAX(Tₐᵤⱼ) | |

Based on the above-mentioned latency parameters, the DU may update the transmit boundary relationship as shown in below table 4.

TABLE 4

| | | | Updated DU transmit |
|---|---|---|---|
| DU Timing | | Parameter | boundary relationship |
| Uplink | No earlier than | Tₐ₄ₘᵢₙ | Tₐ₄ₘᵢₙ ≤ (Tₐ₃ₘᵢₙ + |
| | | | Tₐᵤₘᵢₙ) + T₃₄ₘᵢₙ |
| (Receive) | No later than | Tₐ₄ₘₐₓ | Tₐ₄ₘₐₓ ≥ (Tₐ₃ₘₐₓ + |
| | | | Tₐᵤₘₐₓ) + T₃₄ₘₐₓ |

The above may be latency parameters that may be used to adjust the transmission/reception window position of O-DU (in time).

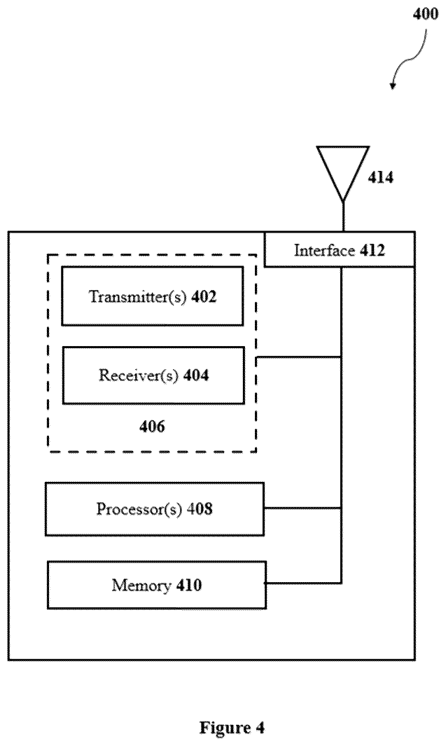

Referring now to FIG. 4 which shows a high-level block diagram of an apparatus 400 for extending eCPRI based delay measurement procedure in distributed antenna systems (DASs), in accordance with some aspects of the present disclosure. In one non-limiting aspect, the apparatus 400 for extending eCPRI based delay measurement procedure may be implemented in an Open Radio Access Network (O-RAN) shared cell in Fronthaul Multiplexer (FHM) mode.

The apparatus 400 may comprise at least one transmitter 402, at least one receiver 404, at least one processor 408, at least one memory 410, at least one interface 412, and at least one antenna 414. The at least one transmitter 402 may be configured to transmit data/information to one or more entities using the antenna 414 and the at least one receiver 404 may be configured to receive data/information from the one or more nodes/devices using the antenna 414. The at least one transmitter and receiver may be collectively implemented as a single transceiver module 406. In one non-limiting aspect, the at least one processor 408 may be communicatively coupled with the transceiver 406, memory 410, interface 412, and antenna 414 for implementing the above-described extended eCPRI based delay measurement procedure.

The at least one processor 408 may include, but not restricted to, microprocessors, microcomputers, micro-controllers, central processing units, state machines, logic circuitries, and/or any devices that manipulate signals based on operational instructions. A processor may also be implemented as a combination of computing devices, e.g., a combination of a plurality of microprocessors or any other such configuration. The at least one memory 410 may be communicatively coupled to the at least one processor 408 and may comprise various instructions for extending eCPRI based delay measurement procedure in DASs. The at least one memory 410 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth. The at least one processor 408 may be configured to execute one or more instructions stored in the memory 410.

The interfaces 412 may include a variety of software and hardware interfaces, for example, a web interface, a graphical user interface, an input device-output device (I/O) interface, a network interface and the like. The I/O interfaces may allow the apparatus 400 to communicate with one or more nodes/devices either directly or through other devices. The network interface may allow the apparatus 400 to interact with one or more networks either directly or via any other network.

The at least one processor 408 may be configured to transmit a plurality of delay measurement requests to a remote radio head (RRH). The plurality of delay measurement requests may be transmitted by a distributed unit (DU) to the RRH for uplink delay measurement and downlink delay measurement. The plurality of delay measurement requests may comprise a plurality of downlink delay measurement requests and uplink delay measurement remote requests. The plurality of downlink delay measurement requests may comprise DU timing parameters. The DU timing parameters may comprise a DU timestamp value (t₁) at which each delay measurement request is transmitted, and a DU compensation time (t_{cv1}) required for transmitting the delay measurement request. In one non-limiting aspect, the remote radio head (RRH) may be a Fronthaul Multiplexer (FHM) unit of Open Radio Access Network (O-RAN) shared cell in Fronthaul Multiplexer (FHM) mode. The plurality of RRUs are distributed into one or more simulcast zones, and each simulcast zone comprises one or more RRUs. Further, each simulcast zone is connected to the RRH using at least one switch such as aggregation switch or access switch as discussed in above.

In the first solution, the RRH may transmit a plurality of dummy packets of variable size, either to a plurality of remote radio units (RRUs) or a furthest and a nearest RRU among the plurality of RRUs, connected to the RRH in response to receiving plurality of delay measurement requests. Each dummy data packet is transmitted along with RRH timing parameters. The RRH timing parameters may comprise a RRH timestamp value (t₁₋₁) at which each dummy packet is transmitted and a RRH compensation time (t_{cv1-1}) required for transmitting the dummy packet. The determination of the furthest and the nearest RRU among the plurality of RRUs is discussed in detail in below aspects.

In the second solution, the at least one processor 408 may be configured to transmit a plurality of dummy packets of variable size, either to a plurality of remote radio units (RRUs) or a furthest and a nearest RRU among the plurality of RRUs, connected to the RRH with or without receiving any delay measurement request from the DU. In such a scenario, the RRH may operate as master and plurality of remote radio units (RRUs) or a furthest RRU may operate as slave.

The RRH may receive a plurality of delay samples in response to the plurality of dummy packets being transmitted, either from each of the plurality of RRUs or the furthest and the nearest RRU. Each of the plurality of delay samples comprises a RRU timestamp value (t₂₋₁) and a RRU compensation time (t_{cv2-1}). In the first solution, the RRH may be configured to update the plurality of delay samples with RRH time stamp value (t₂) and RRH compensation value (t_{cv2}) and forward the plurality of delay samples to the DU. The DU may not be aware of the plurality of RRUs being connected to the RRH and may consider that the plurality of delay samples are received from the RRH.

The transmission and reception between the RRH and RRUs or furthest and the nearest RRU may be carried out using any proprietary communication protocol known to a person skilled in the art or using eCPRI delay measurement procedure. The proprietary communication protocol may be used in cases where eCPRI delay measurement procedure is not supported between the RRH and RRUs.

In the first solution, the at least one processor 408 may be configured to determine downlink transport delays (T₁₂ₘₐₓ/T₁₂ₘᵢₙ) at least based on the plurality of delay samples and DU timing parameters. The at least one processor 408 may be configured to determine uplink transport delays (T₃₄ₘₐₓ/T₃₄ₘᵢₙ) at least based on the plurality of delay samples. These determinations are carried out at the DU. The at least one processor 408 may be configured to adjust a DU transmission window and a DU reception window based on the downlink transport delays (T₁₂ₘₐₓ/T₁₂ₘᵢₙ) and the uplink transport delays (T₃₄ₘₐₓ/T₃₄ₘᵢₙ), respectively.

In the first solution, the at least one processor 408 may be configured to transmit a distributed unit (DU) delay profile to the RRH for adjustment of a RRH transmission window and a RRH reception window. The DU delay profile may comprise the downlink transport delays (T₁₂ₘₐₓ/T₁₂ₘᵢₙ) and the uplink transport delays (T₃₄ₘₐₓ/T₃₄ₘᵢₙ).

In one non-limiting aspect, the RRH may act as a middle node updating the processing delay and forwarding the updated timestamp to RRUs both in uplink and downlink directions as if DU eCPRI node is directly measuring delay between DU and RRU. Then, the RRH transmits the DU delay profile to the plurality of RRUs and each RRU of the plurality of RRUs updates a respective RRU delay profile based on the DU delay profile. Further, the at least one processor 408 may be configured to receive, from the RRH, the updated RRU delay profiles of the plurality of RRUs and adjust the DU transmission window and the DU reception window based on updated RRU delay profiles.

The transmission of the plurality of dummy packet to a plurality of RRUs of each DAS simulcast zone in a DAS, processing all the delay samples received from the plurality of RRUs, and providing updated delay samples to DU with timing parameters of RRH for the calculation of DU delay profile/antenna delay parameters may require considerable time, which may add to the latency. Thus, in order to reduce the processing of all the delay samples received from the plurality of RRUs, the present disclosure aims to consider only the furthest RRU among the plurality of RRUs and nearest RRU among the plurality of RRUs for dummy packet transmission as it will automatically cover the maximum and the minimum value of the antenna delay parameters. This optimization of collecting only the delay samples from the furthest RRU and the nearest RRU for measuring the antenna delay parameters/DU delay profile only with respect to the furthest RRU and the nearest RRU reduces the unnecessary processing of the delay samples received from the plurality of RRUs. However, such optimization is not known to the DU.

In an aspect of the present disclosure, the furthest and the nearest RRU may be determined using a static or a dynamic technique. In the static technique, at least one processor 408 may be configured to determine the furthest RRU among the plurality of RRUs connected to the RRH by determining a RRU having a longest fiber cable length connecting the RRU to a furthest switch from the RRH. Similarly, the nearest RRU among the plurality of RRUs may be determined by determining a RRU having a shortest fiber cable length connecting the RRU to a nearest switch from the RRH. In the dynamic technique, at least one processor 408 may be configured to determine a number of hops between the RRH and each of the plurality of RRUs using traceroute. The number of hops indicates a number of switches connecting the RRH to each of the plurality of RRUs. The at least one processor 408 may be then configured to group one or more RRUs, among the plurality of RRUs, based on the number of hops such that the one or more RRUs having equal number of hops are grouped together, ping the one or more RRUs having a maximum number of hops, and determine the furthest RRU among the one or more RRUs having a maximum response time based on the pinging. Similarly, the nearest RRU among the plurality of RRUs may be determined by pinging the one or more RRUs having a minimum number of hops and determining the nearest RRU among the one or more RRUs having a minimum response time based on the pinging.

In the first solution, the at least one processor 408 may be configured to determine the furthest and the nearest RRU for each simulcast zone. For determining the downlink transport delays (T₁₂ₘₐₓ/T₁₂ₘᵢₙ) and the uplink transport delays (T₃₄ₘₐₓ/T₃₄ₘᵢₙ), the at least one processor 408 is configured to determine downlink transport delays (T₁₂ₘₐₓ/T₁₂ₘᵢₙ) and uplink transport delays (T₃₄ₘₐₓ/T₃₄ₘᵢₙ) based on a plurality of delay samples received from the furthest and the nearest RRU of each simulcast zone. The downlink transport delays (T₁₂ₘₐₓ/T₁₂ₘᵢₙ) and the uplink transport delays (T₃₄ₘₐₓ/T₃₄ₘᵢₙ) of each simulcast zone varies at least based on a number of switches present between the RRH and respective simulcast zone.

The first solution is applicable when the DU does not support adaptive delay parameters. The first solution enables minimal change in O-RAN Control, User and Synchronization Plane (CUS) specification as the antenna delay parameters (T_{da} and Tₐᵤ) are included in the downlink transport delay T₁₂ and the uplink transport delay T₃₄.

In the second solution, the at least one processor 408 may be configured to determine a plurality of adaptive delay parameters based on the plurality of delay samples and the RRH timing parameters. The plurality of adaptive delay parameters may comprise a maximum uplink antenna delay (T_{au_max}), a minimum uplink antenna delay (T_{au_min}), a maximum downlink antenna delay (T_{da_max}), and a minimum downlink antenna delay (T_{da_min}). The determination of the plurality of adaptive delay parameters may be carried out at the RRH itself. The at least one processor 408 may be then configured to store the plurality of adaptive delay parameters with the RRH in the memory containers.

The second solution is applicable when the DU supports and considers T_{da} and Tₐᵤ as measurable adaptive delay parameters. The adaptive delay parameters are introduced to the DU through an updated O-RAN delay management yang model when the DU supports adaptive delay parameters. The updated O-RAN delay management yang model comprises the adaptive delay parameters containers that are exchanged between the DU and RRH for adjusting their respective transmission and reception window.

In the second solution, the at least one processor 408 may be configured to transmit the plurality of adaptive delay parameters to a distributed unit (DU) for adjusting a DU transmission window and a DU reception window. The at least one processor 408 may be then configured to receive, from a distributed unit (DU), a DU delay profile comprising downlink transport delays (T₁₂ₘₐₓ/T₁₂ₘᵢₙ) and uplink transport delays (T₃₄ₘₐₓ/T₃₄ₘᵢₙ). The DU delay profile is measured between the DU and the RRH using Enhanced Common Public Radio Interface (eCPRI) delay measurement procedure. However, the DU delay profile measurement is not restricted to the above technique and the DU delay profile measurement may be carried out using any other technique.

In one non-limiting aspect, the RRH may act as a middle node updating the processing delay and forwarding the updated timestamp to RRUs both in uplink and downlink directions as if DU eCPRI node is directly measuring delay between DU and RRU. Then, the at least one processor 408 may also be configured to transmit the DU delay profile to the plurality of RRUs, and each RRU of the plurality of RRUs updates a respective RRU delay profile based on the DU delay profile. The at least one processor 408 may be then configured to receive the updated RRU delay profiles of the plurality of RRUs and adjust a RRH transmission window and a RRH reception window at least based on the DU delay profile and the updated RRU delay profiles.

In an aspect of the present disclosure, to determine the plurality of adaptive delay parameters, the at least one processor 408 may be configured to determine the plurality of adaptive delay parameters based on a plurality of delay samples received from the furthest and the nearest RRU of each simulcast zone. The plurality of adaptive delay parameters of each simulcast zone varies at least based on a number of switches present between the RRH and respective simulcast zone.

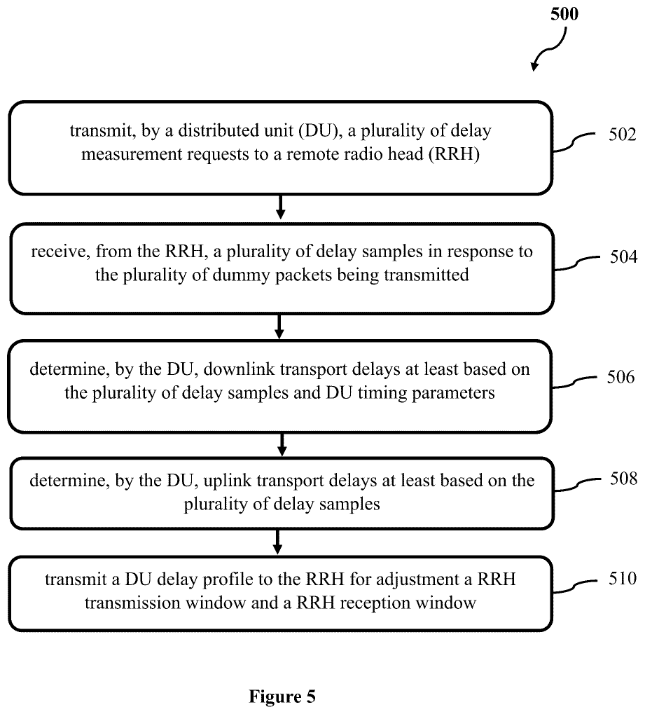

Referring now to FIG. 5, a flowchart is described illustrating an exemplary method 500 of extending eCPRI based delay measurement procedure in distributed antenna systems (DASs), according to an aspect of the present disclosure. The method 500 is merely provided for exemplary purposes, and aspects are intended to include or otherwise cover any extended eCPRI based delay measurement methods or procedures.

The method 500 may include, at block 502, transmitting, from a distributed unit (DU), a plurality of delay measurement requests to a remote radio head (RRH). The plurality of delay measurement requests may be transmitted from a distributed unit (DU) 102 to the RRH for uplink delay measurement and downlink delay measurement. The plurality of delay measurement requests may comprise a plurality of downlink delay measurement requests and uplink delay measurement remote requests. The plurality of downlink delay measurement requests comprises DU timing parameters. The DU timing parameters may comprise a DU timestamp value (t₁) at which each delay measurement request is transmitted, and a DU compensation time (t_{cv1}) required for transmitting the delay measurement request.

In one non-limiting aspect, the remote radio head (RRH) may be a Fronthaul Multiplexer (FHM) unit of Open Radio Access Network (O-RAN) shared cell in Fronthaul Multiplexer (FHM) mode. The plurality of RRUs are distributed into one or more simulcast zones, and each simulcast zone comprises one or more RRUs. Further, each simulcast zone is connected to the RRH using at least one switch such as aggregation switch or access switch as discussed above.

The RRH transmits a plurality of dummy packets of variable size along with RRH timing parameters, either to a plurality of remote radio units (RRUs) or a furthest and a nearest RRU among the plurality of RRUs, connected to the RRH in response to receiving the plurality of delay measurement requests. The dummy data packets are being transmitted along with RRH timing parameters. The RRH timing parameters may comprise a RRH timestamp value (t₁₋₁) at which each dummy packet is transmitted and a RRH compensation time (t_{cv1-1}) required for transmitting the dummy packet. The transmission and reception between the RRH and RRUs or the furthest and nearest RRU may be carried out using any proprietary communication protocol known to a person skilled in the art or using eCPRI delay measurement procedure. The proprietary communication protocol may be used in cases where eCPRI delay measurement procedure is not supported between the RRH and RRUs. The plurality of RRUs and the RRH are implemented in a distributed access system (DAS) or Open Radio Access Network (O-RAN) shared cell in Fronthaul Multiplexer (FHM) mode. The determination of the furthest and the nearest RRU among the plurality of RRUs is discussed in detail in below aspects.

At block 504, the method 500 may include receiving, from the RRH, a plurality of delay samples in response to the plurality of dummy packets being transmitted. The RRH may update the plurality of delay samples with RRH time stamp value (t₂) and RRH compensation value (t_{cv2}) and forward the plurality of delay samples to the DU, which is received by DU in step 504. The DU may not be aware of the plurality of RRUs being connected to the RRH and may consider that the plurality of delay samples are received from the RRH.

At block 506, the method 500 may include determining downlink transport delays (T₁₂ₘₐₓ/T₁₂ₘᵢₙ) at least based on the plurality of delay samples and DU timing parameters. The determination may be performed by the DU. In one non-limiting aspect, the downlink transport delay may also comprise average downlink transport delays (T_{12avg}).

At block 508, the method 500 may include determining uplink transport delays (T₃₄ₘₐₓ/T₃₄ₘᵢₙ) at least based on the plurality of delay samples. The determination may be performed by the DU. In one non-limiting aspect, the downlink transport delay may also comprise average downlink transport delays (T_{34avg}).

At block 510, the method 500 may include transmitting a DU delay profile to the RRH for adjustment of a RRH transmission window and a RRH reception window. The DU delay profile comprises the downlink transport delays (T₁₂ₘₐₓ/T₁₂ₘᵢₙ) and the uplink transport delays (T₃₄ₘₐₓ/T₃₄ₘᵢₙ).

The method 500 may further include adjusting a DU transmission window and a DU reception window based on the downlink transport delays (T₁₂ₘₐₓ/T₁₂ₘᵢₙ) and the uplink transport delays (T₃₄ₘₐₓ/T₃₄ₘᵢₙ), respectively.

In one non-limiting aspect, the RRH may act as a middle node updating the processing delay and forwarding the updated timestamp to RRUs both in uplink and downlink directions as if DU eCPRI node is directly measuring delay between DU and RRU. Then, The RRH transmits the DU delay profile to the plurality of RRUs and each RRU of the plurality of RRUs updates a respective RRU delay profile based on the DU delay profile. The RRH adjusts a RRH transmission window and a RRH reception window at least based on the DU delay profile and the updated delay profiles of the plurality of RRUs. The RRH may further transmit the updated RRU delay profiles of the plurality of RRUs to the DU.

In an aspect of the present disclosure, the furthest and the nearest RRU may be determined using a static or a dynamic technique. In the static technique, the method 500 may comprise determining the furthest RRU among the plurality of RRUs connected to the RRH. For determining the furthest RRU among the plurality of RRUs, the method 500 may comprise determining a RRU having a longest fiber cable length connecting the RRU to a furthest switch from the RRH. Similarly, the nearest RRU among the plurality of RRUs may be determined by determining a RRU having a shortest fiber cable length connecting the RRU to a nearest switch from the RRH.

In the dynamic technique, the method 500 may comprise determining a number of hops between the RRH and each of the plurality of RRUs using traceroute. The number of hops indicates a number of switches connecting the RRH to each of the plurality of RRUs. The method 500 may then comprise grouping one or more RRUs, among the plurality of RRUs, based on the number of hops such that the one or more RRUs having equal number of hops are grouped together, pinging the one or more RRUs having a maximum number of hops, and determining the furthest RRU among the one or more RRUs having a maximum response time based on the pinging. Similarly, the nearest RRU among the plurality of RRUs may be determined by pinging the one or more RRUs having a minimum number of hops and determining the nearest RRU among the one or more RRUs having a minimum response time based on the pinging.

In one non-limiting aspect of the present disclosure, the furthest and the nearest RRU may be determined for each simulcast zone. For determining the plurality of downlink delay parameters and uplink delay parameters, the determining the downlink transport delays (T₁₂ₘₐₓ/T₁₂ₘᵢₙ) and the uplink transport delays (T₃₄ₘₐₓ/T₃₄ₘᵢₙ) may comprise determining downlink transport delays (T₁₂ₘₐₓ/T₁₂ₘᵢₙ) and uplink transport delays (T₃₄ₘₐₓ/T₃₄ₘᵢₙ) based on a plurality of delay samples received from the furthest and the nearest RRU of each simulcast zone. The downlink transport delays (T₁₂ₘₐₓ/T₁₂ₘᵢₙ) and the uplink transport delays (T₃₄ₘₐₓ/T₃₄ₘᵢₙ) of each simulcast zone varies at least based on a number of switches present between the RRH and respective simulcast zone.

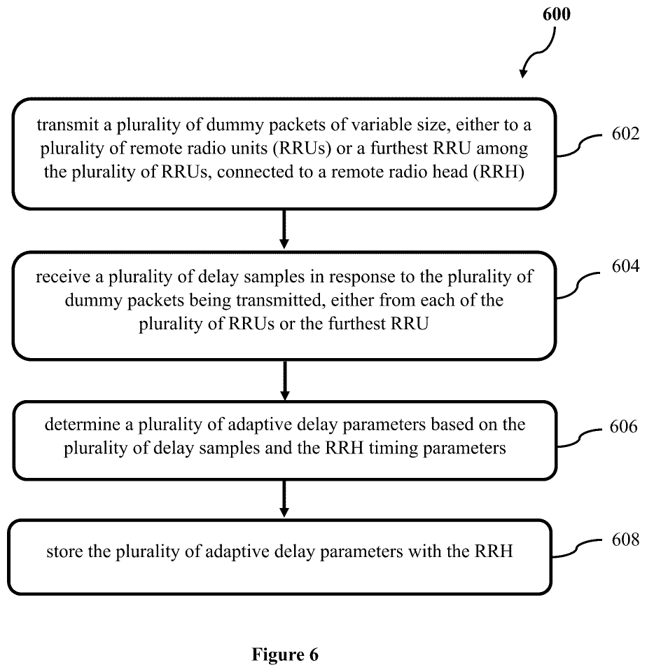

Referring now to FIG. 6, a flowchart is described illustrating another exemplary method 600 of extending eCPRI based delay measurement procedure in distributed antenna systems (DASs), according to an aspect of the present disclosure. The method 600 is merely provided for exemplary purposes, and aspects are intended to include or otherwise cover any extended eCPRI based delay measurement methods or procedures.

The method 600 may include, at block 602, transmitting a plurality of dummy packets of variable size, either to a plurality of remote radio units (RRUs) or a furthest and a nearest RRU among the plurality of RRUs, connected to a remote radio head (RRH). In such a scenario, the RRH may operate as master and plurality of remote radio units (RRUs) or a furthest and a nearest RRU may operate as slave. Each dummy data packet is transmitted along with RRH timing parameters. The RRH timing parameters may comprise a RRH timestamp value (t₁₋₁) at which each dummy packet is transmitted and a RRH compensation time (t_{cv1-1}) required for transmitting the dummy packet. In one non-limiting aspect, the remote radio head (RRH) may be a Fronthaul Multiplexer (FHM) unit of Open Radio Access Network (O-RAN) shared cell in Fronthaul Multiplexer (FHM) mode. The plurality of RRUs are distributed into one or more simulcast zones, and each simulcast zone comprises one or more RRUs. Further, each simulcast zone is connected to the RRH using at least one switch such as aggregation switch or access switch as discussed above.

In an aspect, the plurality of dummy packets of variable size are transmitted either to the plurality of RRUs or the furthest and the nearest RRU among the plurality of RRUs, in response to receiving a plurality of delay measurement requests from a distributed unit (DU). In another aspect, the plurality of dummy packets of variable size are transmitted either to the plurality of RRUs or the furthest and the nearest RRU among the plurality of RRUs without receiving any delay measurement request from a distributed unit (DU).

At block 604, the method 600 may include receiving a plurality of delay samples in response to the plurality of dummy packets being transmitted, either from each of the plurality of RRUs or the furthest and the nearest RRU. Each of the plurality of delay samples comprises a RRU timestamp value (t₂₋₁) and a RRU compensation time (t_{cv2-1}).

The transmission and reception between the RRH and RRUs or the furthest and the nearest RRU may be carried out using any proprietary communication protocol known to a person skilled in the art or using eCPRI delay measurement procedure. The proprietary communication protocol may be used in cases where eCPRI delay measurement procedure is not supported between the RRH and RRUs.

At block 606, the method 600 may include determining a plurality of adaptive delay parameters based on the plurality of delay samples and the RRH timing parameters. The plurality of adaptive delay parameters may comprise a maximum uplink antenna delay (T_{au_max}), a minimum uplink antenna delay (T_{au_min}), a maximum downlink antenna delay (T_{da_max}), and a minimum downlink antenna delay (T_{da_min}).

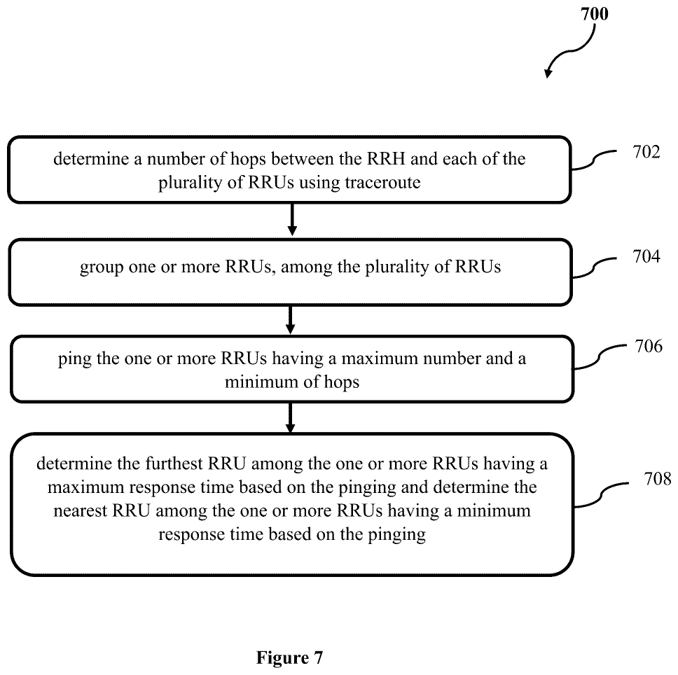

In an aspect of the present disclosure, the furthest RRU may be determined using a static or a dynamic technique. In the static technique, the method 600 may comprise determining the furthest RRU among the plurality of RRUs connected to the RRH. For determining the furthest RRU among the plurality of RRUs, the method 600 may comprise determining a RRU having a longest fiber cable length connecting the RRU to a furthest switch from the RRH. Similarly, the nearest RRU among the plurality of RRUs may be determined by determining a RRU having a shortest fiber cable length connecting the RRU to a nearest switch from the RRH. The dynamic technique for determining the furthest RRU and the nearest RRU is discussed in detail in explanation of FIG. 7.

In one non-limiting aspect of the present disclosure, the furthest and the nearest RRU may be determined for each simulcast zone. For determining the plurality of adaptive delay parameters, the method 600 may further comprise determining a plurality of adaptive delay parameters based on a plurality of delay samples received from the furthest and the nearest RRU of each simulcast zone. The plurality of adaptive delay parameters of each simulcast zone varies at least based on a number of switches present between the RRH and respective simulcast zone.

At block 608, the method 600 may include storing the plurality of adaptive delay parameters with the RRH in the memory containers. The method 600 may also include transmitting the plurality of adaptive delay parameters to the DU for adjusting a DU transmission window and a DU reception window. Thus, the method 600 is applicable when the DU supports/understands adaptive delay parameters. The adaptive delay parameters are introduced to the DU through an updated O-RAN delay management yang model when the DU supports adaptive delay parameters. The updated O-RAN delay management yang model comprises the adaptive delay parameters that are exchanged between the DU and RRH.

In an aspect of the present disclosure, the method 600 may include adjusting a RRH transmission window and a RRH reception window based on the plurality of adaptive delay parameters. The method 600 may further include receiving, from a distributed unit (DU), a DU delay profile comprising downlink transport delays (T₁₂ₘₐₓ/T₁₂ₘᵢₙ) and uplink transport delays (T₃₄ₘₐₓ/T₃₄ₘᵢₙ). The DU delay profile may be measured between the DU and the RRH using Enhanced Common Public Radio Interface (eCPRI) delay measurement procedure. However, the DU delay profile measurement is not restricted to the above technique and the DU delay profile measurement may be carried out using any other technique.

In one non-limiting aspect, the RRH may act as a middle node updating the processing delay and forwarding the updated timestamp to RRUs both in uplink and downlink directions as if DU eCPRI node is directly measuring delay between DU and RRU. Then, the method 600 may include transmitting the DU delay profile to the plurality of RRUs and each RRU of the plurality of RRUs updates a respective RRU delay profile based on the DU delay profile. The method 600 may further include receiving the updated RRU delay profiles of the plurality of RRUs and adjusting a RRH transmission window and a RRH reception window at least based on the DU delay profile and the updated RRU delay profiles.

In an aspect of the present disclosure, for determining the plurality of downlink delay parameters and uplink delay parameters, the method 600 may include determining a plurality of downlink delay parameters and uplink delay parameters based on a plurality of delay samples received from the furthest and the nearest RRU of each simulcast zone. The plurality of downlink delay parameters and uplink delay parameters of each simulcast zone varies at least based on a number of switches present between the RRH and respective simulcast zone.

Referring now to FIG. 7, a flowchart is described illustrating exemplary method 700 another exemplary method 700 for dynamically determining a furthest and a nearest remote radio unit (RRU) in a distributed antenna system (DAS), according to an aspect of the present disclosure. The method 700 is merely provided for exemplary purposes, and aspects are intended to include or otherwise cover any dynamic furthest and the nearest RRU determination methods or procedures.

The method 700 may include, at block 702, determining a number of hops between the RRH and each of the plurality of RRUs using traceroute. The number of hops indicates a number of switches connecting the RRH to each of the plurality of RRUs. The switches may comprise an aggregation switch or a combination of the aggregation switch or an access switch. However, the method of determining the number of hops is not limited to above example and any other technique for determining the number of hops known to a person skilled in the art is well within the scope of present disclosure.

At block 704, the method 700 may include grouping one or more RRUs, among the plurality of RRUs, based on the number of hops such that the one or more RRUs having equal number of hops are grouped together. At block 706, the method 700 may include pinging the one or more RRUs having a maximum and a minimum number of hops and receiving a response from each of the one or more RRUs. The method 700 may also include determining a response time for each of the one or more RRUs.

At block 706, the method 700 may include determining the furthest RRU among the one or more RRUs having a maximum response time based on the pinging. In one non-limiting aspect, the method 700, at block 706, may further comprise determining the nearest RRU among the one or more RRUs having a minimum response time based on the pinging.

Thus, in order to reduce the processing of all the delay samples received from the plurality of RRUs, the present disclosure aims to consider only the furthest RRU and the nearest RRU among the plurality of RRUs for dummy packet transmission as it will automatically cover the maximum and minimum value of antenna delay parameters. This optimization of measuring the antenna delay parameters only with respect to the furthest RRU and the nearest RRU reduces the unnecessary processing of the delay samples received from the plurality of RRUs.

The above methods 500, 600, 700 may be described in the general context of computer executable instructions. Generally, computer executable instructions can include routines, programs, objects, components, data structures, procedures, modules, and functions, which perform specific functions or implement specific abstract data types.

The various blocks of the methods 500, 600, 700 shown in FIGS. 5-7 have been arranged in a generally sequential manner for ease of explanation. However, it is to be understood that this arrangement is merely exemplary, and it should be recognized that the processing associated with methods 500, 600, 700 (and the blocks shown in FIGS. 5-7) can occur in a different order (for example, where at least some of the processing associated with the blocks is performed in parallel and/or in an event-driven manner). Additionally, individual blocks may be deleted from the methods without departing from the spirit and scope of the subject matter described herein. Furthermore, the methods can be implemented in any suitable hardware, software, firmware, or combination thereof.

The various operations of methods described above may be performed by any suitable means capable of performing the corresponding functions. The means may include various hardware and/or software component(s) and/or module(s). Generally, where there are operations illustrated in Figures, those operations may have corresponding counterpart means-plus-function components.

It may be noted here that the subject matter of some or all aspects described with reference to FIGS. 1, 2A, 2B, 3A, and 3B may be relevant for the methods and the same is not repeated for the sake of brevity.

In a non-limiting aspect of the present disclosure, one or more non-transitory computer-readable media may be utilized for implementing the aspects consistent with the present disclosure. A computer-readable media refers to any type of physical memory (such as the memory 410) on which information or data readable by a processor may be stored. Thus, a computer-readable media may store one or more instructions for execution by the at least one processor 408, including instructions for causing the at least one processor 408 to perform steps or stages consistent with the aspects described herein. The term “computer-readable media” should be understood to include tangible items and exclude carrier waves and transient signals. By way of example, and not limitation, such computer-readable media can comprise Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Thus, certain non-limiting aspects may comprise a computer program product for performing the operations presented herein. For example, such a computer program product may comprise a computer readable media having instructions stored (and/or encoded) thereon, the instructions being executable by one or more processors to perform the operations described herein. For certain non-limiting aspects, the computer program product may include packaging material.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise.

A description of an aspect with several components in communication with each other does not imply that all such components are required. On the contrary, a variety of optional components are described to illustrate the wide variety of possible aspects of the disclosed methods and systems.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the aspects of the present disclosure are intended to be illustrative, but not limiting, of the scope of the disclosure, which is set forth in the appended claims.

### Example Embodiments

Example 1 includes method comprising: transmitting, by a distributed unit (DU), a plurality of delay measurement requests to a remote radio head (RRH) for uplink delay measurement and downlink delay measurement, wherein each of the plurality of downlink delay measurement requests comprises DU timing parameters, wherein the RRH transmits a plurality of dummy packets of variable size along with RRH timing parameters, either to a plurality of remote radio units (RRUs) or a furthest and a nearest RRU among the plurality of RRUs, connected to the RRH in response to receiving the plurality of delay measurement requests; receiving, from the RRH, a plurality of delay samples in response to the plurality of dummy packets being transmitted; determining, by the DU, downlink transport delays at least based on the plurality of delay samples and DU timing parameters; determining, by the DU, uplink transport delays at least based on the plurality of delay samples; and transmitting a DU delay profile to the RRH for adjustment a RRH transmission window and a RRH reception window, wherein the DU delay profile comprises the downlink transport delays and the uplink transport delays.

Example 2 includes the method of Example 1, wherein the DU timing parameters comprise a DU timestamp value and a DU compensation time, and wherein each of the plurality of delay sample comprises RRH timing parameters including a RRH timestamp value and a RRH compensation time.

Example 3 includes the method of any of Examples 1-2, wherein the plurality of RRUs and the RRH are implemented in a distributed access system (DAS) or Open Radio Access Network (O-RAN) shared cell in Fronthaul Multiplexer (FHM) mode.

Example 4 includes the method of any of Examples 1-3, further comprising: adjusting a DU transmission window and a DU reception window based on the downlink transport delays and the uplink transport delays respectively.

Example 5 includes the method of any of Examples 1-4, wherein the RRH transmits the DU delay profile to the plurality of RRUs, wherein each RRU of the plurality of RRUs updates a respective RRU delay profile based on the DU delay profile.

Example 6 includes the method of Example 5, further comprising, receiving, from the RRH, the updated RRU delay profiles of the plurality of RRUs.

Example 7 includes the method of Example 6, wherein the RRH adjusts a RRH transmission window and a RRH reception window at least based on the DU delay profile and the updated delay profiles of the plurality of RRUs.

Example 8 includes the method of any of Examples 1-7, wherein the plurality of delay samples are received by the RRH using one of a proprietary communication protocol, or an Enhanced Common Public Radio Interface (eCPRI) delay measurement procedure.

Example 9 includes the method of any of Examples 1-8, further comprising: determining the furthest and the nearest RRU among the plurality of RRUs connected to the RRH, wherein determining the furthest and the nearest RRU among the plurality of RRUs comprises: determining a RRU having a longest fiber cable length connecting the RRU to a furthest switch from the RRH; and determining a RRU having a shortest fiber cable length connecting the RRU to a nearest switch from the RRH.

Example 10 includes the method of any of Examples 1-9, further comprising: determining the furthest and the nearest RRU among the plurality of RRUs connected to the RRH, wherein determining the furthest and nearest RRU among the plurality of RRUs comprises: determining a number of hops between the RRH and each of the plurality of RRUs using traceroute, wherein the number of hops indicates a number of switches connecting the RRH to each of the plurality of RRUs; grouping one or more RRUs, among the plurality of RRUs, based on the number of hops such that the one or more RRUs having equal number of hops are grouped together; pinging the one or more RRUs having a maximum number of hops and pinging the one or more RRUs having a minimum number of hops; and determining the furthest RRU among the one or more RRUs having a maximum response time based on the pinging and determining the nearest RRU among the one or more RRUs having a minimum response time based on the pinging.

Example 11 includes the method of any of Examples 1-10, wherein the plurality of RRUs are distributed into one or more simulcast zones, and wherein each simulcast zone comprises one or more RRUs.

Example 12 includes the method of Example 11, wherein each simulcast zone is connected to the RRH using at least one switch.

Example 13 includes the method of any of Examples 11-12, wherein determining the furthest and the nearest RRU comprises determining the furthest and the nearest RRU for each simulcast zone, and wherein determining the downlink transport delays and the uplink transport delays comprises determining downlink transport delays and uplink transport delays based on a plurality of delay samples received from the furthest and the nearest RRU of each simulcast zone.

Example 14 includes the method of Example 13, wherein the downlink transport delays and the uplink transport delays of each simulcast zone varies at least based on a number of switches present between the RRH and respective simulcast zone.

Example 15 includes a method comprising: transmitting a plurality of dummy packets of variable size, either to a plurality of remote radio units (RRUs) or a furthest and a nearest RRU among the plurality of RRUs, connected to a remote radio head (RRH), wherein each dummy data packet is transmitted along with RRH timing parameters; receiving a plurality of delay samples in response to the plurality of dummy packets being transmitted, either from each of the plurality of RRUs or the furthest and the nearest RRU; determining a plurality of adaptive delay parameters based on the plurality of delay samples and the RRH timing parameters, wherein the plurality of adaptive delay parameters comprises a maximum uplink antenna delay, a minimum uplink antenna delay, a maximum downlink antenna delay, and a minimum downlink antenna delay; and storing the plurality of adaptive delay parameters with the RRH.

Example 16 includes the method of Example 15, further comprising: transmitting the plurality of adaptive delay parameters to a distributed unit (DU) for adjusting a DU transmission window and a DU reception window.

Example 17 includes the method of any of Examples 15-16, wherein the plurality of dummy packets of variable size are transmitted either to the plurality of RRUs or the furthest and the nearest RRU among the plurality of RRUs, in response to receiving a plurality of delay measurement requests from a distributed unit (DU).

Example 18 includes the method of any of Examples 15-17, wherein the plurality of RRUs and the RRH are implemented in a distributed access system (DAS) or Open Radio Access Network (O-RAN) shared cell in Fronthaul Multiplexer (FHM) mode.

Example 19 includes the method of any of Examples 15-18, further comprising: receiving, from a distributed unit (DU), a DU delay profile comprising downlink transport delays and uplink transport delays, wherein the DU delay profile is measured between the DU and the RRH using an Enhanced Common Public Radio Interface (eCPRI) delay measurement procedure; and transmitting the DU delay profile to the plurality of RRUs, wherein each RRU of the plurality of RRUs updates a respective RRU delay profile based on the DU delay profile.

Example 20 includes the method of Example 19, further comprising, receiving the updated RRU delay profiles of the plurality of RRUs.

Example 21 includes the method of any of Examples 19-20, further comprising: adjusting a RRH transmission window and a RRH reception window at least based on the DU delay profile and the updated RRU delay profiles.

Example 22 includes the method of any of Examples 15-21, wherein the plurality of delay samples are received using one of a proprietary communication protocol, or an Enhanced Common Public Radio Interface (eCPRI) delay measurement procedure.

Example 23 includes the method of any of Examples 15-22, further comprising: determining the furthest and the nearest RRU among the plurality of RRUs connected to the RRH, wherein determining the furthest and the nearest RRU among the plurality of RRUs comprises: determining a RRU having a longest fiber cable length connecting the RRU to a furthest switch from the RRH; and determining a RRU having a shortest fiber cable length connecting the RRU to a nearest switch from the RRH.

Example 24 includes the method of any of Examples 15-23, further comprising: determining the furthest and the nearest RRU among the plurality of RRUs connected to the RRH, wherein determining the furthest and the nearest RRU among the plurality of RRUs comprises: determining a number of hops between the RRH and each of the plurality of RRUs using traceroute, wherein the number of hops indicates a number of switches connecting the RRH to each of the plurality of RRUs; grouping one or more RRUs, among the plurality of RRUs, based on the number of hops such that the one or more RRUs having equal number of hops are grouped together; pinging the one or more RRUs having a maximum number of hops and pinging the one or more RRUs having a minimum number of hops; and determining the furthest RRU among the one or more RRUs having a maximum response time based on the pinging and determining the nearest RRU among the one or more RRUs having a minimum response time based on the ping.

Example 25 includes the method of any of Examples 15-24, wherein the plurality of RRUs are distributed into one or more simulcast zones, and wherein each simulcast zone comprises one or more RRUs.

Example 26 includes the method of Example 25, wherein each simulcast zone is connected to the RRH using at least one switch.

Example 27 includes the method of any of Examples 25-26, wherein determining the furthest and the nearest RRU comprises determining the furthest and the nearest RRU for each simulcast zone, and wherein determining the plurality of adaptive delay parameters comprises determining the plurality of adaptive delay parameters based on a plurality of delay samples received from the furthest and the nearest RRU of each simulcast zone.

Example 28 includes the method of Example 27, wherein the plurality of adaptive delay parameters of each simulcast zone varies at least based on a number of switches present between the RRH and respective simulcast zone.

Example 29 includes an apparatus comprising: a memory; and at least one transceiver; and at least one processor communicatively coupled with the memory and the at least one transceiver, wherein the at least one processor is configured to: transmit a plurality of delay measurement requests to a remote radio head (RRH) for uplink delay measurement and downlink delay measurement, wherein each of the plurality of downlink delay measurement requests comprises DU timing parameters, wherein the RRH transmits a plurality of dummy packets of variable size along with RRH timing parameters, either to a plurality of remote radio units (RRUs) or a furthest and a nearest RRU among the plurality of RRUs, connected to the RRH in response to receiving the plurality of delay measurement requests; receive a plurality of delay samples in response to the plurality of dummy packets being transmitted; determine downlink transport delays at least based on the plurality of delay samples and DU timing parameters; determine uplink transport delays at least based on the plurality of delay samples; and transmit a distributed unit (DU) delay profile to the RRH for adjustment of a RRH transmission window and a RRH reception window, wherein the DU delay profile comprises the downlink transport delays and the uplink transport delays.

Example 30 includes the apparatus of Example 29, wherein the DU timing parameters comprise a DU timestamp value and a DU compensation time, and wherein each of the plurality of delay sample comprises RRH timing parameters including a RRH timestamp value and a RRH compensation time.

Example 31 includes the apparatus of any of Examples 29-30, wherein the plurality of RRUs and the RRH are implemented in a distributed access system (DAS) or an Open Radio Access Network (O-RAN) shared cell in Fronthaul Multiplexer (FHM) mode.

Example 32 includes the apparatus of any of Examples 29-31, wherein the at least one processor is further configured to: adjust a DU transmission window and a DU reception window based on the downlink transport delays and the uplink transport delays respectively.

Example 33 includes the apparatus of any of Examples 29-32, wherein the RRH transmits the DU delay profile to the plurality of RRUs, wherein each RRU of the plurality of RRUs updates a respective RRU delay profile based on the DU delay profile.

Example 34 includes the apparatus of Example 33, wherein the at least one processor is further configured to: receive, from the RRH, the updated RRU delay profiles of the plurality of RRUs.

Example 35 includes the apparatus of Example 34, wherein the RRH adjusts a RRH transmission window and a RRH reception window at least based on the DU delay profile and the updated delay profiles of the plurality of RRUs.

Example 36 includes the apparatus of any of Examples 29-35, wherein the plurality of delay samples are received using one of a proprietary communication protocol, or an Enhanced Common Public Radio Interface (eCPRI) delay measurement procedure.

Example 37 includes the apparatus of any of Examples 29-36, wherein the at least one processor is further configured to: determine the furthest and the nearest RRU among the plurality of RRUs connected to the RRH, wherein to determine the furthest and the nearest RRU among the plurality of RRUs, the at least one processor is configured to: determine a RRU having a longest fiber cable length connecting the RRU to a furthest switch from the RRH; determine a RRU having a shortest fiber cable length connecting the RRU to a nearest switch from the RRH.

Example 38 includes the apparatus of any of Examples 29-37, wherein the at least one processor is further configured to: determine the furthest and the nearest RRU among the plurality of RRUs connected to the RRH, wherein to determine the furthest and the nearest RRU among the plurality of RRUs, the at least one processor is configured to: determine a number of hops between the RRH and each of the plurality of RRUs using traceroute, wherein the number of hops indicates a number of switches connecting the RRH to each of the plurality of RRUs; group one or more RRUs, among the plurality of RRUs, based on the number of hops such that the one or more RRUs having equal number of hops are grouped together; ping the one or more RRUs having a maximum number of hops and ping the one or more RRUs having a minimum number of hops; and determine the furthest RRU among the one or more RRUs having a maximum response time based on the ping and determine the nearest RRU among the one or more RRUs having a minimum response time based on the pinging.

Example 39 includes the apparatus of any of Examples 29-38, wherein the plurality of RRUs are distributed into one or more simulcast zones, and wherein each simulcast zone comprises one or more RRUs.

Example 40 includes the apparatus of Example 39, wherein each simulcast zone is connected to the RRH using at least one switch.

Example 41 includes the apparatus of any of Examples 39-40, wherein to determine the furthest and the nearest RRU, the at least one processor is configured to determine the furthest and the nearest RRU for each simulcast zone, and wherein to determine the downlink transport delays and the uplink transport delays, the at least one processor is configured to determine downlink transport delays and uplink transport delays based on a plurality of delay samples received from the furthest and the nearest RRU of each simulcast zone.

Example 42 includes the apparatus of Example 41, wherein the downlink transport delays and the uplink transport delays of each simulcast zone varies at least based on a number of switches present between the RRH and respective simulcast zone.

Example 43 includes an apparatus comprising: a memory; and at least one transceiver; and at least one processor communicatively coupled with the memory and the at least one transceiver, wherein the at least one processor is configured to: transmit a plurality of dummy packets of variable size, either to a plurality of remote radio units (RRUs) or a furthest and a nearest RRU among the plurality of RRUs, connected to a remote radio head (RRH), wherein each dummy data packet is transmitted along with RRH timing parameters; receive a plurality of delay samples in response to the plurality of dummy packets being transmitted, either from each of the plurality of RRUs or the furthest and the nearest RRU; determine a plurality of adaptive delay parameters based on the plurality of delay samples and the RRH timing parameters, wherein the plurality of adaptive delay parameters comprises a maximum uplink antenna delay, a minimum uplink antenna delay, a maximum downlink antenna delay, and a minimum downlink antenna delay; and store the plurality of adaptive delay parameters with the RRH.

Example 44 includes the apparatus of Example 43, wherein the at least one processor is further configured to: transmit the plurality of adaptive delay parameters to a distributed unit (DU) for adjusting a DU transmission window and a DU reception window.

Example 45 includes the apparatus of any of Examples 43-44, wherein the plurality of dummy packets of variable size are transmitted either to the plurality of RRUs or the furthest and the nearest RRU among the plurality of RRUs, in response to receipt of a plurality of delay measurement requests from a distributed unit (DU).

Example 46 includes the apparatus of any of Examples 43-45, wherein the plurality of RRUs and the RRH are implemented in a distributed access system (DAS) or an Open Radio Access Network (O-RAN) shared cell in Fronthaul Multiplexer (FHM) mode.

Example 47 includes the apparatus of any of Examples 43-46, wherein the at least one processor is further configured to: receive, from a distributed unit (DU), a DU delay profile comprising downlink transport delays and uplink transport delays, wherein the DU delay profile is measured between the DU and the RRH using an Enhanced Common Public Radio Interface (eCPRI) delay measurement procedure; and transmit the DU delay profile to the plurality of RRUs, wherein each RRU of the plurality of RRUs updates a respective RRU delay profile based on the DU delay profile.

Example 48 includes the apparatus of Example 47, wherein the at least one processor is further configured to: receive the updated RRU delay profiles of the plurality of RRUs.

Example 49 includes the apparatus of any of Examples 47-48, wherein the at least one processor is configured to: adjust a RRH transmission window and a RRH reception window at least based on the DU delay profile and the updated RRU delay profiles.

Example 50 includes the apparatus of any of Examples 43-49, wherein the plurality of delay samples are received using one of a proprietary communication protocol, or an Enhanced Common Public Radio Interface (eCPRI) delay measurement procedure.

Example 51 includes the apparatus of any of Examples 43-50, wherein the at least one processor is further configured to: determine the furthest and the nearest RRU among the plurality of RRUs connected to the RRH, wherein to determine the furthest and the nearest RRU among the plurality of RRUs, the at least one processor is configured to: determine a RRU having a longest fiber cable length connecting the RRU to a furthest switch from the RRH; and determine a RRU having a shortest fiber cable length connecting the RRU to a nearest switch from the RRH.

Example 52 includes the apparatus of any of Examples 43-51, wherein the at least one processor is further configured to: determine the furthest and the nearest RRU among the plurality of RRUs connected to the RRH, wherein to determine the furthest and the nearest RRU among the plurality of RRUs, the at least one processor is further configured to: determine a number of hops between the RRH and each of the plurality of RRUs using traceroute, wherein the number of hops indicates a number of switches connecting the RRH to each of the plurality of RRUs; group one or more RRUs, among the plurality of RRUs, based on the number of hops such that the one or more RRUs having equal number of hops are grouped together; ping the one or more RRUs having a maximum number of hops and ping the one or more RRUs having a minimum number of hops; and determine the furthest RRU among the one or more RRUs having a maximum response time based on the ping and determine the nearest RRU among the one or more RRUs having a minimum response time based on the ping.

Example 53 includes the apparatus of any of Examples 43-52, wherein the plurality of RRUs are distributed into one or more simulcast zones, and wherein each simulcast zone comprises one or more RRUs.

Example 54 includes the apparatus of Example 53, wherein each simulcast zone is connected to the RRH using at least one switch.

Example 55 includes the apparatus of any of Examples 53-54, wherein to determine the furthest and the nearest RRU, the at least one processor is configured to determine the furthest and the nearest RRU for each simulcast zone, and wherein to determine the plurality of adaptive delay parameters, the at least one processor is configured to determine the plurality of adaptive delay parameters based on a plurality of delay samples received from the furthest and the nearest RRU of each simulcast zone.

Example 56 includes the apparatus of Example 55, wherein the plurality of adaptive delay parameters of each simulcast zone varies at least based on a number of switches present between the RRH and respective simulcast zone.

Example 57 includes a non-transitory computer-readable medium having computer-readable instructions that when executed by a processor causes the processor to perform operations of: transmitting, by a distributed unit (DU), a plurality of delay measurement requests to a remote radio head (RRH) for uplink delay measurement and downlink delay measurement, wherein each of the plurality of downlink delay measurement requests comprises DU timing parameters, wherein the RRH transmits a plurality of dummy packets of variable size along with RRH timing parameters, either to a plurality of remote radio units (RRUs) or a furthest and a nearest RRU among the plurality of RRUs, connected to the RRH in response to receiving the plurality of delay measurement requests; obtaining, from the RRH, a plurality of delay samples in response to the plurality of dummy packets being transmitted; determining, by the DU, downlink transport delays at least based on the plurality of delay samples and DU timing parameters; determining, by the DU, uplink transport delays at least based on the plurality of delay samples; and transmitting a DU delay profile to the RRH for adjustment a RRH transmission window and a RRH reception window, wherein the DU delay profile comprises the downlink transport delays and the uplink transport delays.

Example 58 includes a non-transitory computer-readable medium having computer-readable instructions that when executed by a processor causes the processor to perform operations of: transmitting a plurality of dummy packets of variable size, either to a plurality of remote radio units (RRUs) or a furthest and a nearest RRU among the plurality of RRUs, connected to a remote radio head (RRH), wherein each dummy data packet is transmitted along with RRH timing parameters; obtaining a plurality of delay samples in response to the plurality of dummy packets being transmitted, either from each of the plurality of RRUs or the furthest and the nearest RRU; determining a plurality of adaptive delay parameters based on the plurality of delay samples and the RRH timing parameters, wherein the plurality of adaptive delay parameters comprises a maximum uplink antenna delay, a minimum uplink antenna delay a maximum downlink antenna delay, and a minimum downlink antenna delay; and storing the plurality of adaptive delay parameters with the RRH.

What is claimed is:

1. A method comprising:
transmitting, by a distributed unit (DU), a plurality of delay measurement requests to a remote radio head (RRH) for uplink delay measurement and downlink delay measurement, wherein each of the plurality of downlink delay measurement requests comprises DU timing parameters,
wherein the RRH transmits a plurality of dummy packets of variable size along with RRH timing parameters, either to a plurality of remote radio units (RRUs) or a furthest and a nearest RRU among the plurality of RRUs, connected to the RRH in response to receiving the plurality of delay measurement requests;
receiving, from the RRH, a plurality of delay samples in response to the plurality of dummy packets being transmitted;
determining, by the DU, downlink transport delays at least based on the plurality of delay samples and DU timing parameters;
determining, by the DU, uplink transport delays at least based on the plurality of delay samples; and
transmitting a DU delay profile to the RRH for adjustment a RRH transmission window and a RRH reception window, wherein the DU delay profile comprises the downlink transport delays and the uplink transport delays.

2. The method of claim 1, wherein the DU timing parameters comprise a DU timestamp value and a DU compensation time, and wherein each of the plurality of delay sample comprises RRH timing parameters including a RRH timestamp value and a RRH compensation time.

3. The method of claim 1, wherein the plurality of RRUs and the RRH are implemented in a distributed access system (DAS) or Open Radio Access Network (O-RAN) shared cell in Fronthaul Multiplexer (FHM) mode.

4. The method of claim 1, further comprising:
adjusting a DU transmission window and a DU reception window based on the downlink transport delays and the uplink transport delays respectively.

5. The method of claim 1, wherein the RRH transmits the DU delay profile to the plurality of RRUs, wherein each RRU of the plurality of RRUs updates a respective RRU delay profile based on the DU delay profile.

6. The method of claim 5, further comprising,
receiving, from the RRH, the updated RRU delay profiles of the plurality of RRUs.

7. The method of claim 6, wherein the RRH adjusts a RRH transmission window and a RRH reception window at least based on the DU delay profile and the updated delay profiles of the plurality of RRUs.

8. The method of claim 1, wherein the plurality of delay samples are received by the RRH using one of a proprietary communication protocol, or an Enhanced Common Public Radio Interface (eCPRI) delay measurement procedure.

9. The method of claim 1, further comprising:
determining the furthest and the nearest RRU among the plurality of RRUs connected to the RRH, wherein determining the furthest and the nearest RRU among the plurality of RRUs comprises:
determining a RRU having a longest fiber cable length connecting the RRU to a furthest switch from the RRH; and
determining a RRU having a shortest fiber cable length connecting the RRU to a nearest switch from the RRH.

10. The method of claim 1, further comprising:
determining the furthest and the nearest RRU among the plurality of RRUs connected to the RRH,
wherein determining the furthest and nearest RRU among the plurality of RRUs comprises:
determining a number of hops between the RRH and each of the plurality of RRUs using traceroute, wherein the number of hops indicates a number of switches connecting the RRH to each of the plurality of RRUs;
grouping one or more RRUs, among the plurality of RRUs, based on the number of hops such that the one or more RRUs having equal number of hops are grouped together;
pinging the one or more RRUs having a maximum number of hops and pinging the one or more RRUs having a minimum number of hops; and
determining the furthest RRU among the one or more RRUs having a maximum response time based on the pinging and determining the nearest RRU among the one or more RRUs having a minimum response time based on the pinging.

11. The method of claim 1, wherein the plurality of RRUs are distributed into one or more simulcast zones, and wherein each simulcast zone comprises one or more RRUs.

12. The method of claim 11, wherein each simulcast zone is connected to the RRH using at least one switch.

13. The method of claim 11,
wherein determining the furthest and the nearest RRU comprises determining the furthest and the nearest RRU for each simulcast zone, and
wherein determining the downlink transport delays and the uplink transport delays comprises determining downlink transport delays and uplink transport delays based on a plurality of delay samples received from the furthest and the nearest RRU of each simulcast zone.

14. The method of claim 13, wherein the downlink transport delays and the uplink transport delays of each simulcast zone varies at least based on a number of switches present between the RRH and respective simulcast zone.

15. A method comprising:
transmitting a plurality of dummy packets of variable size, either to a plurality of remote radio units (RRUs) or a furthest and a nearest RRU among the plurality of RRUs, connected to a remote radio head (RRH), wherein each dummy data packet is transmitted along with RRH timing parameters;
receiving a plurality of delay samples in response to the plurality of dummy packets being transmitted, either from each of the plurality of RRUs or the furthest and the nearest RRU;
determining a plurality of adaptive delay parameters based on the plurality of delay samples and the RRH timing parameters, wherein the plurality of adaptive delay parameters comprises a maximum uplink antenna delay, a minimum uplink antenna delay, a maximum downlink antenna delay, and a minimum downlink antenna delay; and
storing the plurality of adaptive delay parameters with the RRH.

16. An apparatus comprising:
a memory; and
at least one transceiver; and
at least one processor communicatively coupled with the memory and the at least one transceiver, wherein the at least one processor is configured to:
transmit a plurality of delay measurement requests to a remote radio head (RRH) for uplink delay measurement and downlink delay measurement, wherein each of the plurality of downlink delay measurement requests comprises DU timing parameters,
wherein the RRH transmits a plurality of dummy packets of variable size along with RRH timing parameters, either to a plurality of remote radio units (RRUs) or a furthest and a nearest RRU among the plurality of RRUs, connected to the RRH in response to receiving the plurality of delay measurement requests;
receive a plurality of delay samples in response to the plurality of dummy packets being transmitted;
determine downlink transport delays at least based on the plurality of delay samples and DU timing parameters;
determine uplink transport delays at least based on the plurality of delay samples; and
transmit a distributed unit (DU) delay profile to the RRH for adjustment of a RRH transmission window and a RRH reception window, wherein the DU delay profile comprises the downlink transport delays and the uplink transport delays.

17. The apparatus of claim 16, wherein the DU timing parameters comprise a DU timestamp value and a DU compensation time, and wherein each of the plurality of delay sample comprises RRH timing parameters including a RRH timestamp value and a RRH compensation time.

18. The apparatus of claim 16, wherein the plurality of RRUs and the RRH are implemented in a distributed access system (DAS) or an Open Radio Access Network (O-RAN) shared cell in Fronthaul Multiplexer (FHM) mode.

19. The apparatus of claim 16, wherein the at least one processor is further configured to:
adjust a DU transmission window and a DU reception window based on the downlink transport delays and the uplink transport delays respectively.

20. The apparatus of claim 16, wherein the RRH transmits the DU delay profile to the plurality of RRUs, wherein each RRU of the plurality of RRUs updates a respective RRU delay profile based on the DU delay profile.

21. The apparatus of claim 20, wherein the at least one processor is further configured to:
receive, from the RRH, the updated RRU delay profiles of the plurality of RRUs.

22. The apparatus of claim 21, wherein the RRH adjusts a RRH transmission window and a RRH reception window at least based on the DU delay profile and the updated delay profiles of the plurality of RRUs.

23. The apparatus of claim 16, wherein the plurality of delay samples are received using one of a proprietary communication protocol, or an Enhanced Common Public Radio Interface (eCPRI) delay measurement procedure.

24. The apparatus of claim 16, wherein the at least one processor is further configured to:
determine the furthest and the nearest RRU among the plurality of RRUs connected to the RRH,
wherein to determine the furthest and the nearest RRU among the plurality of RRUs, the at least one processor is configured to:
determine a RRU having a longest fiber cable length connecting the RRU to a furthest switch from the RRH;
determine a RRU having a shortest fiber cable length connecting the RRU to a nearest switch from the RRH.

25. The apparatus of claim 16, wherein the at least one processor is further configured to:
determine the furthest and the nearest RRU among the plurality of RRUs connected to the RRH,
wherein to determine the furthest and the nearest RRU among the plurality of RRUs, the at least one processor is configured to:
determine a number of hops between the RRH and each of the plurality of RRUs using traceroute, wherein the number of hops indicates a number of switches connecting the RRH to each of the plurality of RRUs;
group one or more RRUs, among the plurality of RRUs, based on the number of hops such that the one or more RRUs having equal number of hops are grouped together;
ping the one or more RRUs having a maximum number of hops and ping the one or more RRUs having a minimum number of hops; and
determine the furthest RRU among the one or more RRUs having a maximum response time based on the ping and determine the nearest RRU among the one or more RRUs having a minimum response time based on the pinging.

26. The apparatus of claim 16, wherein the plurality of RRUs are distributed into one or more simulcast zones, and wherein each simulcast zone comprises one or more RRUs.

27. The apparatus of claim 26, wherein each simulcast zone is connected to the RRH using at least one switch.

28. The apparatus of claim 27,
wherein to determine the furthest and the nearest RRU, the at least one processor is configured to determine the furthest and the nearest RRU for each simulcast zone, and
wherein to determine the downlink transport delays and the uplink transport delays, the at least one processor is configured to determine downlink transport delays and uplink transport delays based on a plurality of delay samples received from the furthest and the nearest RRU of each simulcast zone.

29. The apparatus of claim 28, wherein the downlink transport delays and the uplink transport delays of each simulcast zone varies at least based on a number of switches present between the RRH and respective simulcast zone.

30. An apparatus comprising:
a memory; and
at least one transceiver; and
at least one processor communicatively coupled with the memory and the at least one transceiver, wherein the at least one processor is configured to:
transmit a plurality of dummy packets of variable size, either to a plurality of remote radio units (RRUs) or a furthest and a nearest RRU among the plurality of RRUs, connected to a remote radio head (RRH), wherein each dummy data packet is transmitted along with RRH timing parameters;
receive a plurality of delay samples in response to the plurality of dummy packets being transmitted, either from each of the plurality of RRUs or the furthest and the nearest RRU;
determine a plurality of adaptive delay parameters based on the plurality of delay samples and the RRH timing parameters, wherein the plurality of adaptive delay parameters comprises a maximum uplink antenna delay, a minimum uplink antenna delay, a maximum downlink antenna delay, and a minimum downlink antenna delay; and
store the plurality of adaptive delay parameters with the RRH.

31. A non-transitory computer-readable medium having computer-readable instructions that when executed by a processor causes the processor to perform operations of:
transmitting, by a distributed unit (DU), a plurality of delay measurement requests to a remote radio head (RRH) for uplink delay measurement and downlink delay measurement, wherein each of the plurality of downlink delay measurement requests comprises DU timing parameters,
wherein the RRH transmits a plurality of dummy packets of variable size along with RRH timing parameters, either to a plurality of remote radio units (RRUs) or a furthest and a nearest RRU among the plurality of RRUs, connected to the RRH in response to receiving the plurality of delay measurement requests;
obtaining, from the RRH, a plurality of delay samples in response to the plurality of dummy packets being transmitted;
determining, by the DU, downlink transport delays at least based on the plurality of delay samples and DU timing parameters;
determining, by the DU, uplink transport delays at least based on the plurality of delay samples; and
transmitting a DU delay profile to the RRH for adjustment a RRH transmission window and a RRH reception window, wherein the DU delay profile comprises the downlink transport delays and the uplink transport delays.

32. A non-transitory computer-readable medium having computer-readable instructions that when executed by a processor causes the processor to perform operations of:
transmitting a plurality of dummy packets of variable size, either to a plurality of remote radio units (RRUs) or a furthest and a nearest RRU among the plurality of RRUs, connected to a remote radio head (RRH), wherein each dummy data packet is transmitted along with RRH timing parameters;
obtaining a plurality of delay samples in response to the plurality of dummy packets being transmitted, either from each of the plurality of RRUs or the furthest and the nearest RRU;
determining a plurality of adaptive delay parameters based on the plurality of delay samples and the RRH timing parameters, wherein the plurality of adaptive delay parameters comprises a maximum uplink antenna delay, a minimum uplink antenna delay a maximum downlink antenna delay, and a minimum downlink antenna delay; and
storing the plurality of adaptive delay parameters with the RRH.
